(19) United States
(12) Patent Application Publication
(10) Pub. No.: US 2023/0117517 A1
(43) Pub. Date: Apr. 20, 2023

(54) ENZYMATIC CONSTRUCTION MATERIAL

(71) Applicant: Worcester Polytechnic Institute, Worcester, MA (US)

(72) Inventors: Nima Rahbar, Weston, MA (US); Suzanne F. Scarlata, Worcester, MA (US); Shuai Wang, Worcester, MA (US)

(21) Appl. No.: 17/943,548

(22) Filed: Sep. 13, 2022

Related U.S. Application Data
(60) Provisional application No. 63/243,494, filed on Sep. 13, 2021.

(51) Int. Cl. C04B 26/02; C04B 14/06; C04B 24/14; C04B 14/30

(52) U.S. Cl. CPC C04B 26/026; C04B 14/06; C04B 14/308; C04B 24/14; C04B 2111/00017

(57) ABSTRACT

Materials and methods for a rapid and effective way to create a carbon negative self-healing construction material are described. The construction material uses sand aggregates, a trace amount of catalyst, a small dosage of scaffolding material with a crosslinking agent, and a calcium source. The curing is performed at a high temperature for a short period or at room temperature for a long period. The catalyst-driven method to bridge the sand particles results in a dense, stiff, strong, and tough structural material, which upon exposure to calcium source and CO₂ heals itself repeatably.

### RELATED APPLICATIONS

This application claims the benefit under 35 U.S.C. § 119(e) of U.S. Provisional application no. 63/243,494, filed Sep. 13, 2021, entitled “ENZYMATIC CONSTRUCTION MATERIAL”, by inventors Nima Rahbar, Shuai Wang, and Suzanne Scarlata, which is hereby incorporated by reference herein in its entirety.

### BACKGROUND

Concrete is an invaluable building material owing to its compressive strength and resistance to atmospheric elements. Concrete is a general term applied to a mixture of Portland cement and aggregate, typically sand and gravel of various sizes. The Portland cement reacts with water to bind the aggregate and cure to form a solid mass. Concrete is easily transported as a dry material having a powdery, gravel texture, and forms a fluidic, granular slurry type of material immediately after mixing with water. Prior to curing, the fluidic mixture may be cast or poured into any suitable shape; about 90 minutes after mixing with water it begins to cure into the molded shape and manifests substantial compressive strength and mass.

Apart from water, concrete is the most consumed material on earth with three tons per year used for every person. Every year, waste concrete from construction and carbon dioxide emission from the cement production and transport is increasing, and concrete alone contributes to 9% of total CO₂ emission. The average temperatures in the Arctic have been rising faster than anywhere on earth, this is due to the rise in sea level caused by the greenhouse effect. Climate change caused by increased CO₂ levels due to human activity is the biggest existential threat facing the world. Therefore, reducing carbon dioxide emissions to reduce the greenhouse effect is an urgent task. Methods to reduce concrete consumption with high volume pozzolans replacements such as fly ash and slag in concrete consumption are not environmentally friendly.

Therefore, there is a need to develop novel, environmentally friendly methods and compositions for concrete and concrete repair.

### SUMMARY

A negative emission Enzymatic Construction Material (ECM) with self-healing capabilities can be used as an alternative to concrete and Portland cement. The disclosed approach employs carbonic anhydrase (CA) to catalyze the condensation of carbon dioxide and water to promote the precipitation of calcium ions in the aqueous solution as calcium carbonate crystals. As a result, a functional and biological ECM was obtained, whose compressive strength and Young’s modulus properties are more than twice that of the cement mortars and other alternative building materials. The growth of mineral bridges that hold the sand particles were also modeled and studied. The approach provides a beneficial path for environmentally friendly construction materials.

Configurations herein depict a carbon negative self-healing construction material compound, including a quantity of aggregates such as sand and gravel, a catalyst such as an enzyme, a scaffolding material having a crosslinking agent, and a calcium source.

The mixture including the enzyme is configured to bridge sand particles in the quantity of aggregates for forming a dense, solid mass. This enzyme-driven method to bridge the sand particles results in a dense, stiff, strong, and tough structural material, which upon exposure to calcium source and CO₂ can also heal itself repeatably. As described herein, catalyst and enzyme are interchangeably used.

Production of ECM adsorbs CO₂, hence not only it can reduce the current 9% global CO₂ emission caused by concrete production and repair, but it can also be used for carbon sequestration. The material is environmentally friendly, odorless, and harmless to human with the highest mechanical strength (~12 MPa) reported for an alternative construction material. Additionally, the curing process of ECM (a few days at ambient temperature) is significantly faster than traditional concrete at 28 days.

An aspect of the invention described herein provides a self-healing construction material compound, the compound including: an aggregate matter; a catalyst such as an enzyme; a scaffolding material; and a calcium source. In an embodiment of the compound, the compound is a carbon negative compound.

In an embodiment of the compound, the aggregate matter further includes sand aggregates. In an embodiment of the compound, the scaffolding material further includes a crosslinking agent selected from glutaraldehyde, and tannin. In an embodiment of the compound, the scaffolding material includes a polymer. In an embodiment of the compound, the scaffolding material is gelatin. In an embodiment of the compound, the catalyst is an enzyme such as carbonic anhydrase or a chemical analog of carbonic anhydrase or a synthetically manufactured carbonic anhydrase.

An embodiment of the compound further includes a source of carbon dioxide. In an embodiment of the compound, the compound sequesters atmospheric carbon dioxide. The compound has a mechanical strength from at least 10 MPa to at least 16 MPa.

An embodiment of the compound further includes at least one of: a light source, a heat source, a laser source, and a magnetic field application source. In an embodiment of the compound, the compound is configured to form mineral bridges between the aggregate matter to obtain a dense mass. In an embodiment of the compound, the catalyst is configured to operate at a pH of 6.5 to 8.5 and to operate at a temperature of 30° C. to 50° C. An embodiment of the compound further includes a quantity of nanoparticles.

An aspect of the invention described herein provides a method for making a carbon sequestering construction material, the method including: preparing a solution having the catalyst and a calcium solution; mixing an aggregate matter with a scaffolding material to obtain a slurry; and adding the catalytic solution and the calcium solution to the slurry, such that the CA or analog utilizes carbon dioxide from atmosphere and calcium from the calcium solution to form calcium carbonate crystals thereby sequestering carbon and obtaining a carbon sequestering construction material.

In an embodiment of the method, the calcium carbonate crystals are deposited on the aggregate matter to create mineral bridges. An embodiment of the method further includes dehydrating the construction material for facilitating crosslinking between scaffolding material. In an embodiment of the method, the calcium solution is configured to facilitate continuous precipitation of the calcium carbonate crystals.

An aspect of the invention described herein provides a carbon negative self-healing construction material compound, the compound including: a quantity of sand aggregates; a quantity of carbonic anhydrase catalyst; a gelatin scaffolding material; a calcium solution; and a quantity of iron oxide nanoparticles. An embodiment of the compound further includes a laser source or a light source for curing the compound.

### BRIEF DESCRIPTION OF DRAWINGS

FIG. 1 is a schematic drawing illustrating preparation and fabrication of enzymatic construction material (ECM), and the enzymatic healing process.

FIG. 2 is a graph showing the weight gain for four different material designs with constant CO₂ gas treatment with five bubbles per second rate. Adding a base increases the weight gain and the weight gain is the highest for ECa samples. In the box plot, the median value is illustrated as (-), the mean as (_{□}), the values at 25% and 75% as box edges, and the values at 5% and 95% level as whiskers.

FIG. 3 are a set of microphotographs showing the scanning electron microscope (SEM) images and energy dispersive spectroscopy (EDS) maps comparing the effects of the CA enzyme, calcium source and high pH as aqueous solutions additives on different samples. The catalysis of the CA enzymes results in an ECM with an organized structure. Calcium is distributed uniformly on the ECM surfaces and bridges. Compared to control GL (Gelatin), GCa (Gelatin + Ca²⁺), and BGE (Base + gelatin + CA + Ca²⁺) samples, the mineral bridges in the ECM have wider and longer dimensions. The EDS maps of the ECM samples also show the highest amount of calcite crystals in comparison with other three samples.

FIG. 4A- FIG. 4F are a set of microphotographs. FIG. 4A and FIG. 4B show that the dimension of a typical crystal bridge in ‘non gelatin’ sample, ECa, is smaller compared to a typical bridge in ECM. Thereby providing evidence that gelatin has the ability to establish a proper scaffolding framework for crystal formation that further enhances and extends the size of the crystal bridges. FIG. 4C and FIG. 4D show that a typical crack initiates and grows in the calcite bridges bonding the sand particles. FIG. 4E and FIG. 4F show detachment of the sand particles from the matrix.

FIG. 5A is a photograph of a CA sand slurry sample prepared with #No. 50 (the sand retained on a 300 m sieve) white sand. FIG. 5B is a photograph of the CA sand slurry sample after uniaxial compression test. FIG. 5C is a photograph of a CA sand slurry sample prepared with #No. 30 coarse sand (retained on a 600 m sieve). FIG. 5D and FIG. 5E are a set of graphs showing the compressive strength and tangent modulus respectively of the fine sand slurry samples prepared with five different aqueous solutions. ECM is observed to show the highest compressive strength (9 MPa) and shows the highest tangent modulus.

FIG. 6A is a photograph of single edge notch bending (SENB) test. FIG. 6B and FIG. 6C are a set of graphs showing the fracture energy, and the load-displacement curve respectively of three different groups of sand slurry beam samples: GL, GCa and ECM. The results show that ECM samples have the highest fracture energy and ultimate load.

FIG. 7 are a set of microphotographs showing optical (top row), SEM (bottom row) images of the process of enzymatically catalyzed mineral precipitation and growth on the sand-gelatin system within the first 20 minutes of curing.

FIG. 8 is a graph showing time-dependent mineral thickness ratio (H=R) as a function of time. H is the thickness of a mineral bridge, and R is the average thickness of the gelatin network for sand-gelatin system. The solid line represents the numerical result from the diffusion model, and the dots present the data.

FIG. 9A and FIG. 9B are a set of photographs of a single edge notch ECM beam samples before the fracture test and after the fracture test respectively. FIG. 9C is a photograph that shows that the fractured samples were placed in the silicon molds and treated with (3 parts) calcium-enzyme solution and CO₂ gas along the crack region. FIG. 9D is a photograph that shows that after treatment, the crack is healed. FIG. 9E is a set of photographs that show that the healed samples after the desiccation in which the calcium carbonate crystals are visible in the fractured region. The specimen was re-healed in every cycle and the ultimate fracture load for each six cycles is indicated in the FIG. 9F.

FIG. 10 is a schematic drawing of the self-healing mechanism in which after the fracture, upon the application of CO₂, CA’s enzymatic catalysis reestablish the broken mineral bridges using calcium and reconstruct the bridging network that holds the materials’ microstructure together.

FIG. 11 is a graph of the compressive strength of ECM (n=14), glutaraldehyde-modified ECM (n=7), and tannin-modified ECM (n=5). Glutaraldehyde-modified ECM samples exhibit an impressive 12 MPa strength on average.

FIG. 12 is a powder X-ray diffraction (pXRD) analysis of the crystals produced by CA enzyme method compared to the reference spectrum for calcite. The comparison confirms the crystallinity of the product resulting from the enzyme method is calcite.

FIG. 13 is a set of graphs showing Fourier Transform Infrared Spectroscopy (FT-IR) analysis of the enzyme produced Ca-carbonate and compared to a reference spectrum in which the sample precipitate had a dry weight of 0.4 µg, confirming the chemical composition of the repair product resulting from the enzyme solution

FIG. 14A is a photograph of coarse sand slurry cube. FIG. 14B is a graph showing compressive strength of coarse sand slurry cube with CA enzyme catalysis (Gelatin + Ca²⁺ + CA) compared to intact control. The samples perform the highest average compressive strength 4.2 MPa.

FIG. 15A and FIG. 15B is a photograph and graph respectively showing fracture test for coarse sand slurry beam. FIG. 15C is a graph showing results of coarse sand beam bending test.

FIG. 16 is a set of microphotographs showing Optical microscopy images (top row) and SEM images (bottom row) of mineral precipitated and growth in a typical ECM sample within 10 minutes

FIG. 17A is a graph showing concentration of calcium as a function of the radius of a bridge. FIG. 17B is a graph showing a linear approximation of the concentration profile.

FIG. 18 is a schematic drawing illustrating preparation and fabrication of enzymatic construction material-n (ECM-n), the enzymatic healing process and use of laser for curing.

FIG. 19A is a photograph that shows the experimental setup of the laser induced ECM-n curing. FIG. 19B is a thermal imaging showing the top view of the temperature variation of ECM-n. The maximum temperature rises to 81.5° C. at 60 minutes (n = 5, Med = 81.5, SD = 3). FIG. 19C is a thermal imaging showing the side view of the temperature contours in ECM-n. FIG. 19D is a graph showing the temperature as a function of curing time at the center of a 0.1% nanoparticle modified ECM-n 12.5 mm cubic sample surface under 3 W laser induction compared with ECM without nanoparticles. Each data of ECM and ECM-n was taken from a median group of five independent samples (n = 5).

FIG. 20 is a graph showing the normalized heat flow for the initial curing of ECM-n at 25° C. and 60° C. The behavior of the ECM-n heat flow after injecting an enzyme-calcite solution under two different temperatures. Both peaks can be identified within six minutes and then tend to plateau.

FIG. 21A- FIG. 21D are a set of Infrared thermal images of cured ECM-n thermal effect at different temperatures. FIG. 21A shows that the laser heating experiment was set up at ambient temperature for ECM-n. FIG. 21B shows the spatial view of the ECM-n at one-hour laser irradiation. FIG. 21C show he side view of the sample at one hour of laser irradiation. FIG. 21D shows the process of laser heating of ECM-n at -20° C. freezer and the sample’s top surface temperature was raised to 60° C. in 10 minutes.

FIG. 22 is a graph showing the comparison of experiment and simulation about laser heating ECM-n. Temperature changes along the time and laser power for the ECM-n in 30 minutes. The laser was removed for twenty minutes and the materials started to cool to the ambient temperature. The results from experiments and the predictions show reasonable agreement.

FIG. 23A is a schematic illustration of the self-healing capability of ECM-n beam via laser-induced heating. A trace amount of calcium-enzyme solution was added to the fractured area then ultra-pure CO₂ was aerated on the surface for 15 minutes. 3 W laser was conducted in the same location over 4 hours. The heterogeneous shape of the high-temperature region (white color) develops into a circle gradually. FIG. 23B shows µ-CT scanned images of fracture and laser healing ECM-n beam at the front, center, and back layers.

FIG. 24A- FIG. 24I show comparison of the multiscale microstructure and mineralization of ECM-n (left) and ECM (right). FIG. 24B- FIG. 24E show SEM and optical images of laser cured ECM-n and oven cured ECM showing the scaffold bridges and calcite crystals are distributed uniformly. FIG. 24F and FIG. 24G show higher magnification SEM images of scaffold bridges formed by laser curing and oven curing respectively. FIG. 25H and FIG. 24I show the EDS mapping images of the nanoparticle distribution in the matrix and the major chemical compositions.

FIG. 25A- FIG. 25B show the compressive strength of laser repaired ECM-n with different flaws ECM-n samples with different flaw shapes that were repaired and compared with oven-cured ECM. FIG. 25A shows the laser repairing paradigm of ECM-n: The mean results are shown above each data set and a typical sample is shown at the bottom in FIG. 24B. The compressive strength of ECM, in order from left to right are: oven-cured ECM (n=12, blue, M = 9.56, SD = 1.49), laser cured ECM-n (n=10, brown, M= 9.45, SD=1.44), elliptical flaw ECM-n (n=10, grey, M= 6.69, SD=1.92, P=0.003), circular flaw ECM-n (n=10, yellow, M=6.76, SD=1.79, P=0.004), repaired elliptical flaw ECM-n (n=10, light blue, M=9.76, SD=1.86, P=0.43) and repaired circular flaw ECM-n (n=10, green, M=9.47, SD=1.75, P=0.48).

FIG. 26A- FIG. 26C illustrate an Ashby diagram and scaling up ECM-n procedures Carbon footprint and mechanical properties of ECM/ECM-n compared to different construction materials. FIG. 26A shows an Ashby diagram of embodied CO₂ versus embodied energy data. FIG. 26B shows an Ashby diagram of specific strength versus embodied CO₂ for comparison with related construction materials. FIG. 26C shows the procedures of fabricating ECM-n on construction site.

FIG. 27 shows photographs of incandescent light curing of ECM-n sample. The ECM-n sample was cured in 12 hours at the ambient condition.

FIG. 28A- FIG. 28B show the comparison of mass loss and temperature over curing time between ECM n and ECM. FIG. 28A shows variation of the sample’s mass over time for ECM-n cured by 3 W laser at room condition versus ECM. The data of ECM and ECM-n was taken from a median group of five independent samples (n = 5). FIG. 28B shows the temperature as a function of fully cured time at the center of 12.5 mm ECM-n sample surface under 3 W laser induction compared with EICM without nanoparticles. The data were presented by median with a sample size of 3.

FIG. 29A- FIG. 29D show the thermomechanical modeling of ECM-n. The predicted three-dimensional temperature contour and the comparison of maximum temperature between experimental data and proposed prediction for ECM-n samples with different laser power. The heat transfer computation was carried out for three different powers. FIG. 29A shows the FEM mesh of ECM-n. FIG. 29B shows Gaussian profile of order 1. FIG. 29C and FIG. 29D show the 3D and top views of the ECM-n showing the temperature contour at 20 minutes with a 3 W laser illumination.

FIG. 30A- FIG. 30B show the comparison of the self-healed ECM-n samples under the presence of carbonic anhydrase. FIG. 30A shows that fracture sample was healed by calcium solution and CO₂ without enzyme. FIG. 30B shows that fracture sample was healed by calcium solution and CO₂ with the enzyme.

FIG. 31 shows the normalized Raman spectra of four different spots on the cured ECM-n surface. The peak analysis was processed and plotted by fitting the Gaussian function. The calcite and γFe2O3 positions were annotated in the diagram.

FIG. 32 shows a powder X-ray diffraction (pXRD) analysis of the enzyme-generated calcium carbonate in presence of laser induction, with comparison to the reference spectrum for calcite. This comparison confirms the crystallinity of the product after laser curing resulting from the enzyme repair method.

### DETAILED DESCRIPTION

Most of the infrastructure is made of concrete. Every ton of concrete produced releases one ton of CO₂ into the atmosphere. As a result, the concrete industry is the second largest industrial source of CO₂, accounting for about 9% of global emissions. The inventions described herein show a novel enzymatic construction material (ECM) with mechanical properties superior to concrete mortar. The fabrication method requires about 48 hours and is much faster than the fabrication method for current building materials including assemblies based on biological methods, which have a longer curing period and possess less than half of the mechanical properties of ECM. Therefore, ECM is an alternative to cement that bridges the sand particles using a light and inexpensive polymer backbone through the deposition of calcium carbonate crystals, resulting in a hard, solid material that is twice as strong as the cementitious substrate and self-heals upon repeated large-scale cracking by incorporating an enzymatic catalyst. In contrast, cementitious materials or other current building materials do not have a similar capability. The state-of-the-art in active building material is living building material (LBM), which uses photosynthetic cyanobacterium to precipitate calcium carbonate crystals or fungi. LBM fabrication is inefficient because the cost of bacteria is much higher than ECM and the process cannot be not easily operated on a large-scale manufacturing. Most important, the self-healing capability of the LBM is limited, and the material cannot regain its original strength. LBMs can also produce antibiotics such as polymyxin and refractory bacterium which can be biohazardous.

The inventions described herein are developed by applying biological methods to repair concrete through calcium carbonate deposition. Natural enzymes are proteins that catalyze a chemical reaction rapidly without being consumed in the process and are safe and reliable. Carbonic anhydrase (CA) is a fundamental enzyme found across all species. Fourteen isoenzymes of CA have been found in the human body. The structures, properties, and tissue distribution of the different CA isoenzymes are different; however, the isoenzymes have the same critical physiological functions in cell respiration by reacting CO₂ with water to yield carbonic acid in the body tissue and reversing the reaction in the lungs to generate CO₂.

The sequestration of CO₂ is based on chemical fixation of carbonate minerals such as calcite, aragonite, and magnesite. The inventions described herein use a biomimetic CO₂ absorption mechanism using biocatalysts such as CA to reduce local CO₂ concentrations emitted from the production of cement.

Despite numerous attempts to pioneer functional concrete: use of enzyme catalyzed calcium carbonate precipitation to repair concrete, the preparation of self-healing concrete containing bacteria, or the high cost of self-healing concrete containing capsule system, these cannot escape the scope of consuming concrete cement materials as the matrix. To fundamentally solve the CO₂-generating problem of concrete production, a viable substitute material for cement is required.

The technique of microbially-induced calcium carbonate precipitation (MICP) includes applying Synechococcus from photosynthetic cyanobacterium in MICP, to develop long-term viability building materials (LBMs), which present a successive regenerated ability and is an alternative to concrete cement material. However, the mechanical properties of LBMs are not comparable to natural concrete cement, and this material is far from practical construction applications. Additionally, the mechanism of crystal precipitation and growth within the bio-scaffold is not efficient thereby resulting in a material with low density. The bacteria may require maintenance to continued viability.

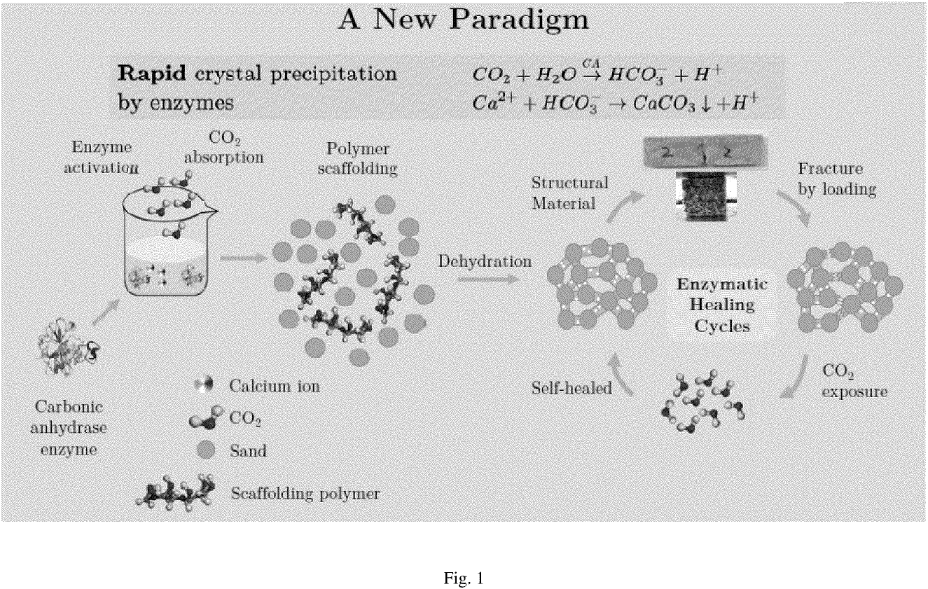

The examples described herein present a faster and effective way to create a negative emission self-healing construction material using sand aggregates, a trace amount of enzyme, a small dosage of scaffolding material with a crosslinking agent, and a calcium source. Curing of the material can be performed at a high temperature in a short period or room temperature for a longer period. This enzyme-driven method to bridge the sand particles results in a dense, stiff, strong, and relatively tough structural material, which upon exposure to calcium source and CO₂ can also heal itself repeatably. Carbonic anhydrase (CA), the enzyme used to generate the new material, can be easily stored and is stable at pH 6.5 - 8.5 and temperature of 30 - 50° C. The reaction conditions generate an environment that promotes enzyme stability, consumes CO₂, and avoids unhealthy reagents and pollutants. The mechanism of crystals growth on the scaffold yields outstanding mechanical properties and self-healing ability due to the catalyzing effect of CA. The enzyme catalyzed process, structure fabrication process and 2D microstructure of the material, called enzyme construction material, ECM, are shown schematically in FIG. 1.

Concrete production and waste significantly contribute to global pollution. Enzymatic building material (ECM) is a low-cost and environment-friendly construction material that possesses superior mechanical properties to concrete through enzyme-catalyzed crystal precipitation. The examples described herein show carbonic anhydrase (CA), an enzyme derived from biological cells, to facilitate the carbonation reaction by converting carbon dioxide to precipitate calcium carbonate crystals. In some embodiments, a synthetic analog of CA is used as the catalyst or enzyme. A polymer backbone (gelatin) provides a scaffolding framework for crystals to form and establish strong crystal bridges to connect the sand particles. The presence of enzymes as catalysts allows ECM to possess self-healing capability. The examples described herein shown that ECM endures six healing cycles, with damage at a specific location, with a loss of about 50% of overall strength. Therefore, ECM is a viable alternative to concrete, as the most used material in the world. ECM has limitless possibilities for green building materials and creation of space construction materials.

The examples described herein introduce a new paradigm in developing a negative-emission construction material with self-healing capability using sand, calcium, gelatin, and trace amount of carbonic anhydrase enzyme, named Enzymatic Construction Material or ECM. ECM possess exceptional mechanical properties as a construction material with a compressive strength (12 MPa) higher than any other available method and is twice as high as cement mortar. Therefore, ECM can be used to repair or even replace Portland cement concrete. The examples described herein examined the influence of CA enzyme catalysis, high pH condition, and gelatin on the overall strengthening and toughening mechanism in the ECM. The data show that wider and longer mineral bridges are incorporated in the microstructure of ECM compared to samples not containing enzyme and/or base samples. The bridges strengthen and toughen the material.

The self-healing capability of ECM was investigated through a cyclic fracture and healing examples, in which the ECM samples withstood up to six cycles of fracture. Therefore, the enzymatic mineralization method is useful to create a negative emission construction material and a method of carbon sequestration. The ECM can be rapidly manufactured with an environmentally friendly procedure, and therefore is a substitute for current building materials.

The ECM requires only a small amount of low-cost polymer as a scaffold and incorporates trace amounts of an enzyme to produce an odorless, inexpensive, environmentally friendly, and mechanically strong material. The ECM can heal itself after multiple damage cycles at the same location demonstrating strong self-healing capacity. In some embodiments, the ECM is cured by baking at low temperatures. In alternative embodiments, the ECM is cured by light. In other embodiments, the ECM is cured by applying a magnetic field.

ECM is a negative emission structural material with self-healing capability which further enhances its durability, and consequently, its negative carbon footprint. The material can be essentially used an alternative carbon sequestration method. ECM alleviates the high monetary and energy costs associated with the production and use of concrete and consumes the greenhouse gas carbon dioxide. Most important, ECM does not use any harmful reagents with foul odors that would limit the application of the final structure. Therefore, ECM provides a novel, low cost, safe and highly efficient way to create a sand slurry material with a strong self-healing capability. ECM is a new material and method for the development of environmentally friendly construction materials. Therefore, Enzymatic Self-Healing Construction Material is negative emission material which consumes CO₂ during production and during its self-healing mechanism.

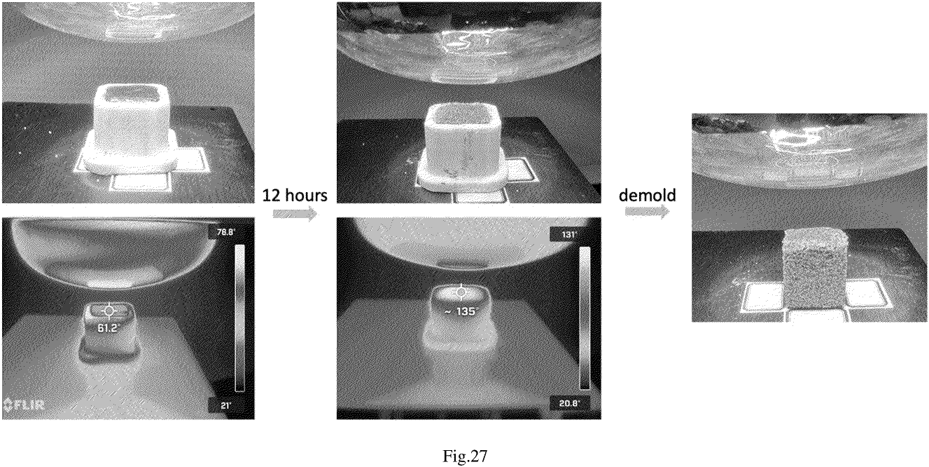

Traditional concrete curing requires an adequate amount of moisture for continued hydration and 28 days to achieve mechanical strength. Compared to concrete, ECM obtains maximum compressive strength in 24 hours by oven heating or more than one week under natural desiccation. However, to reduce the time cost, the application of the oven makes the on-site construction challenging. Embodiments of the invention described herein show that adding a trace amount of iron oxide nanoparticles to ECM generates an improved material called ECM-n that is cured with a low-power laser, or incandescent light (FIG. 27). This method, based on studies of laser-induced nanoparticles application in hyperthermia therapy utilizes the exothermic behavior of iron oxide nanoparticles under external electromagnetic (radiofrequency, microwave, and laser) excitation. Specifically, the ECM-n samples cured for 12 hours under a 3 W laser (808 nm wavelength) have similar compressive strength to ECM. Additionally, fabricating large flaws in ECM-n samples showed accelerated repair with laser exposure and the samples regained mechanical strength and properties comparable to original, flawless samples.

A portion of the embodiments described herein were published in Matter Volume 5, Issue 3, March 2, 2022, Pages 957-974 as “A self-healing enzymatic construction material” by co-inventors Shuai Wang, Suzanne F. Scarlata, and Nima Rahbar, which is hereby incorporated by reference herein in its entirety. Another portion of the embodiments described herein are submitted as a manuscript to Cell Reports Physical Science as “Curing and self-healing of enzymatic construction materials using nanoparticles” by o-inventors Shuai Wang, Suzanne F. Scarlata, and Nima Rahbar, which is hereby incorporated by reference herein in its entirety.

The inventions described herein are the most practical methods. It is recognized, however, that departures may be made within the scope of the invention and that modifications will occur to a person skilled in the art. With respect to the above description then, it is to be realized that the optimum dimensional relationships for the parts of the invention, to include variations in size, materials, shape, form, function, steps, and manner of operation, assembly and use, would be apparent to one skilled in the art, and all equivalent relationships to those illustrated in the drawings and described in the specification are intended to be encompassed by the present inventions.

The following examples and claims are illustrative only and not intended to be further limiting. Those skilled in the art will recognize or be able to ascertain using no more than routine experimentation, numerous equivalents to the specific procedures described herein. Such equivalents are within the scope of the present invention and claims. The contents of all references including issued patents and published patent applications cited in this application are hereby incorporated by reference.

The invention now having been fully described, it is further exemplified by the following examples and claims.

### Example 1: Enzymatic Solution Preparation

The analytical grade carbonic anhydrase (CA), calcium chloride dihydrate, and tris (hydroxymethyl) aminomethane (THAM) were obtained from Sigma Aldrich chemical company. To prepare enzyme matrix solution, 2.9 mg CA and 1 mL deionized water were mixed into aliquots, then shaken evenly in the horizontal direction for two minutes. 5 L of 100 M CA solution were pipetted in each of the empty aliquots and stored in the freezer.

### Example 2: Calcium Carbonate Solution Preparation

To prepare a buffer solution, 0.1 M tris (ordered from Sigma Aldrich) was added to 200 mL deionized water, mixed with 2 M saturated solution, and stirred for two minutes. Calcium chloride dihydrate was chosen as the calcium source because it can generate calcium carbonate more efficiently. High concentration of free calcium ions in the solution expedites the dissolution of calcium chloride dihydrate. When the calcium chloride dihydrate was dissolved substantially, 10 L of 100 M CA solution was added into a 1000 mL beaker and stirred for another two minutes. CO₂ gas was then introduced into the solution at a rate of five bubbles per second for 10 minutes. A pH meter was used to record the entire process. Some fog was observed to be produced from the solution after five minutes. The experiment was ended when the pH reached seven and the flow of CO₂ gas was stopped. The solution was then settled for four hours, and the supernatant was siphoned to prepare a highly concentrated calcium carbonate solution.

### Example 3: Cubic and Cuboid ECM Sample Fabrication

25 mm cubic samples were prepared for uniaxial compressive tests. A loading rate of 1.27 mm/s was chosen. Single edge notch beam samples were prepared for fracture test and plain beam for bending test. 10% gelatin by weight (gelatin/solution) was mixed with sand for two minutes. Gelatin was chosen because of the chemical compatibility with CA, and because the completely soluble temperature of gelatin is 35° C., which is within the temperature range of carbonic anhydrase activity. The sand-gelatin mixture was placed in silicone molds. The calcium carbonate solution was then titrated on the sample surface. The samples were allowed to settle for half-hour until the solution was completely saturated in the matrix. The ECM samples were then desiccated in the 100° C. oven for 24 hours and demolded for testing.

### Example 4: Weight Gain

Four groups of solutions were prepared (Ca: Ca²⁺; BCa: Base + Ca²⁺; BEC: Base + CA +Ca²⁺; ECa: CA + Ca²⁺) similar to the method described in Enzymatic solution preparation. The solution was then aerated with CO₂ gas (5 bubbles per second) for 10 minutes with continuous stirring. The weight of solution was measured immediately after the end of the experiment.

### Example 5: Self-Healing Experiment Procedure

To examine the self-healing capability of ECM, single edge notch beam samples were prepared similar to the method presented in Cubic and cuboid samples fabrication process section. The first cycle initiated with the beam samples that were fractured under three-point bend test and then placed back to the silicon mold. To demonstrate the self-healing process, a constant amount of 2 mL of calcium-enzyme solution was titrated evenly on the surface of the crack region. Then CO₂ gas was aerated through a rubber tube with constant pressure on the crack surface for 10 minutes. Samples were then desiccated in the 100° C. oven for 24 hours, and then underwent the three-point bending fracture test. The fracture/healing procedures were repeated six times and the data were collected.

### Example 6: Glutaraldehyde Modification

50% concentration glutaraldehyde was acquired from TCI AMERICA company as the ECM crosslinking agent. 1:1 gelatin and glutaraldehyde ratio were then added by weight on the surface of the ECM samples. The samples were placed at room temperature for half an hour until the gelatin/glutaraldehyde solution completely penetrated the sample. The samples were then desiccated for another 24 hours then mechanically tested.

### Example 7: X-Ray Diffraction (XRD) and FT-IR Analysis

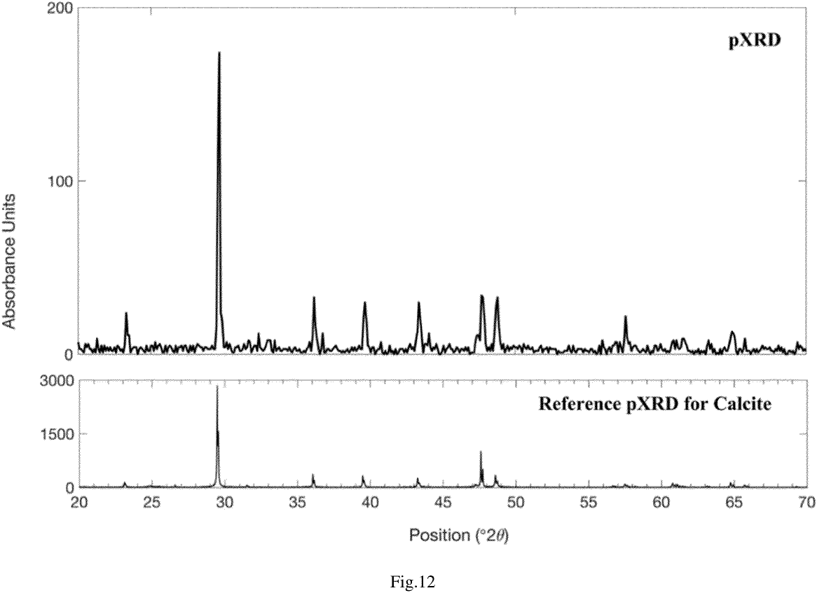

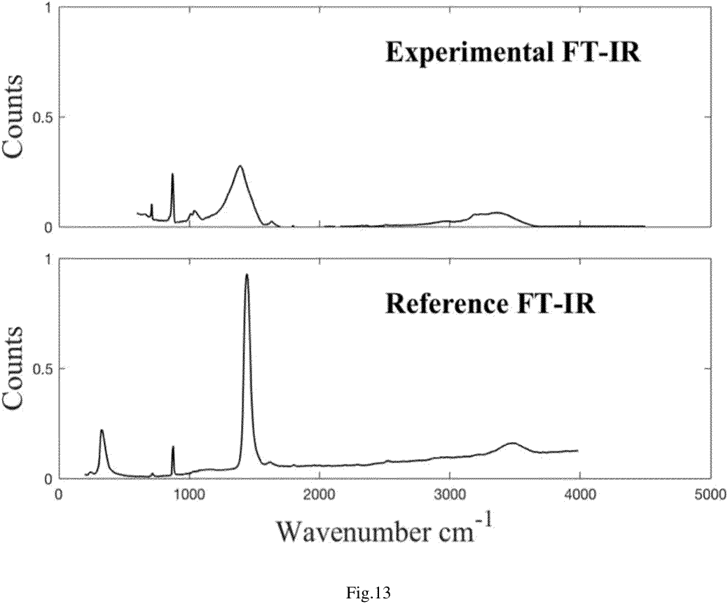

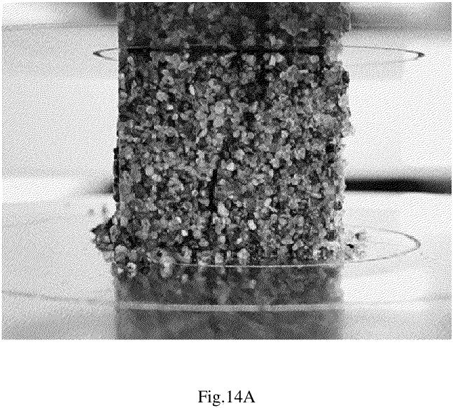

Analysis of the dried enzyme solution product was conducted by powder X-ray diffraction (pXRD) and Fourier Transform Infrared Spectroscopy (FT-IR) to confirm both the chemical composition and crystallinity. pXRD was performed on a Bruker AXS D8 Focus (Bruker, Billerica, MA, 102 of 190 USA) at 25° C., and the pXRD spectrum used a CuKa radiation source at 40 keV and 40 mA from 20° to 90° of 2θ with a step size of 0.100°, against the baseline and FT-IR was carried out on a Bruker Optics Vertex 70 equipped with a Specac Golden Gate Diamond Single Reflection ATR element (Bruker, Billerica, MA, USA). The calcium carbonate prepared from the enzyme solution was rinsed and dried for analysis. FIG. 12 compares the pXRD spectrum against the reference spectrum for calcite, and FIG. 13 compares the FT-IR spectrum of the dried enzyme product against the baseline FT-IR spectrum for Ca-carbonate obtained from the RUFF Project database. Both results clearly verify the chemical composition and crystallinity of the enzyme product as calcite.

### Example 8: Compressive Strength of Cubic Coarse Sand ECM

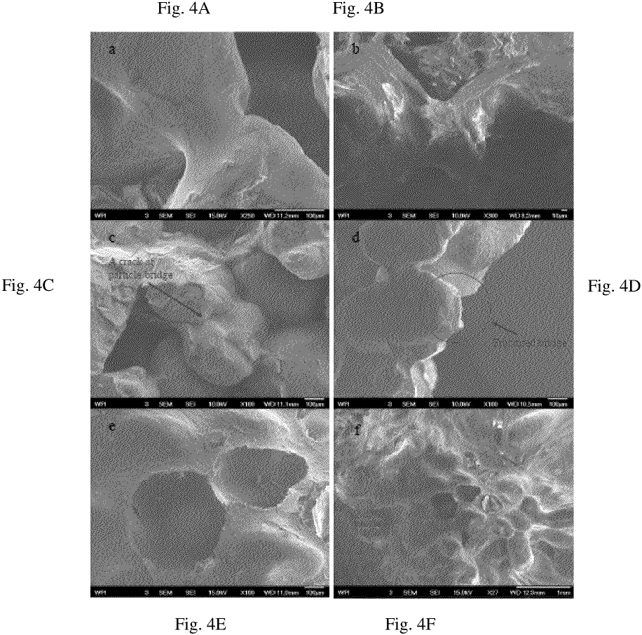

The uniaxial compressive experiments were performed following the American Society for Testing and Materials (ASTM) standards on ECM specimen with coarse sand (NO. 30, the sand retained on a 600 µm sieve as alternative sand mixing in the materials), since ECM design possessed the highest compressive strength compared to intact and high pH specimens in the extensive fine sand experimental plan. The average strength of coarse sand ECM is 4.2 MPa which is lower than fine sand ECM (FIG. 4D). The primary reason is that compressive strength in these samples is predominantly influenced by larger sand aggregate strength, size, and distribution than the size of crystal bridges.

### Example 9: Fracture and Bending Test

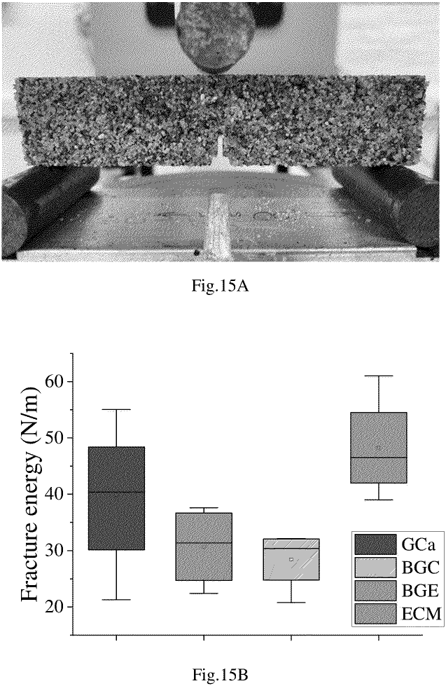

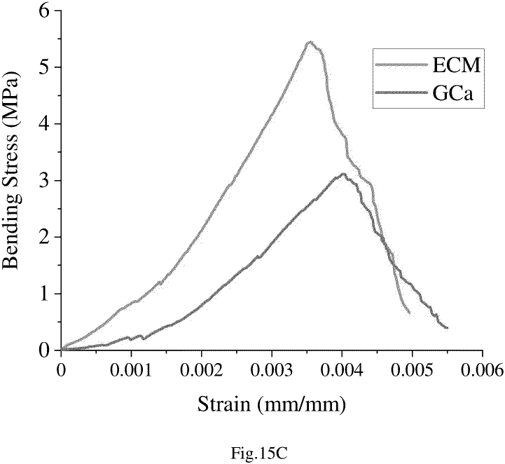

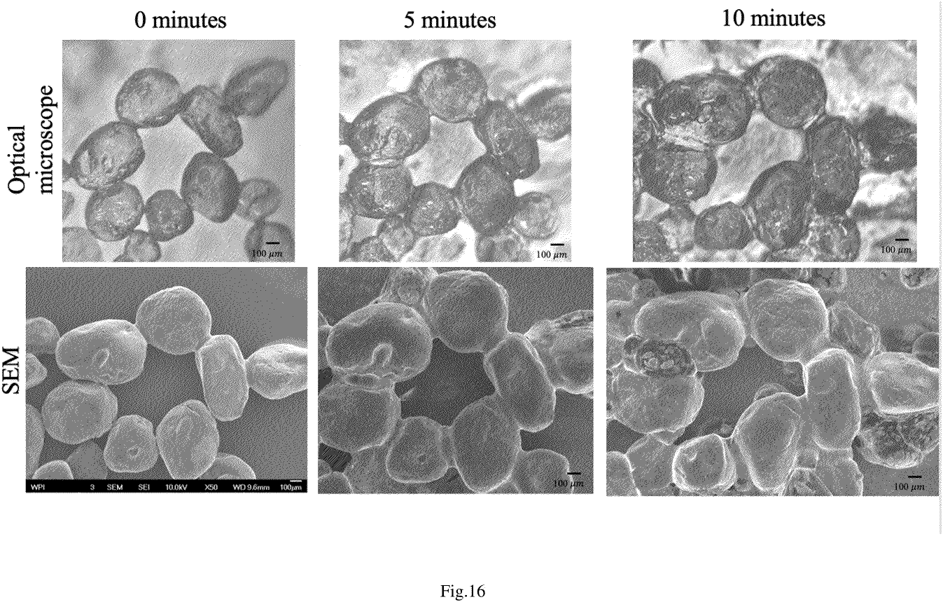

The results of the three-point fracture experiments are presented in FIG. 15A- FIG. 15C. The fracture experiments were followed using the method in ASTM standard. A cured silicone mold with a sharp crack was prepared and used for sample preparation. A four-part solution of 10ml CA enzyme, tris base, 2 M Calcium chloride dihydrate and DI water was prepared. It was then thoroughly mixed for two minutes and bubbling CO₂ gas for 10 minutes. The solution was then titrated on the coarse sand samples and settled for half hour until fully infiltrated into the sand. The samples were then placed in the 100° C. oven for 24 hours and demolded afterwards. Fracture toughness were then calculated following the fracture experiments. Higher fracture energy indicated materials undergo more ductile failure. The data show that the coarse sand ECM sample has the highest average fracture energy (218 N/m).

### Example 10: Crystal Bridge Growth Model

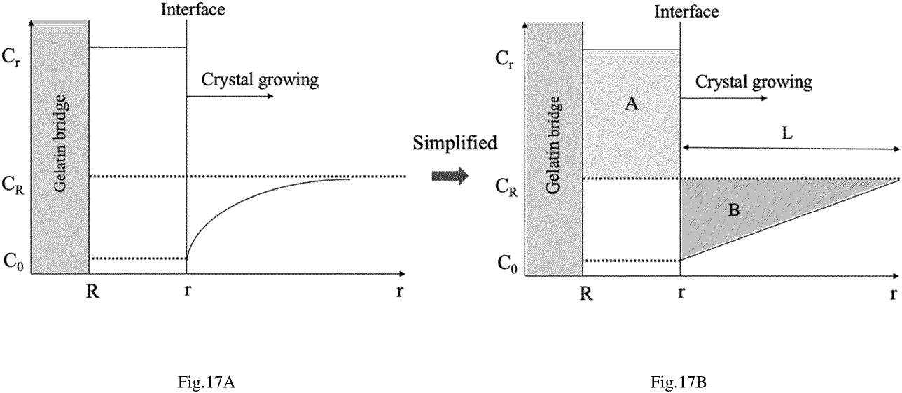

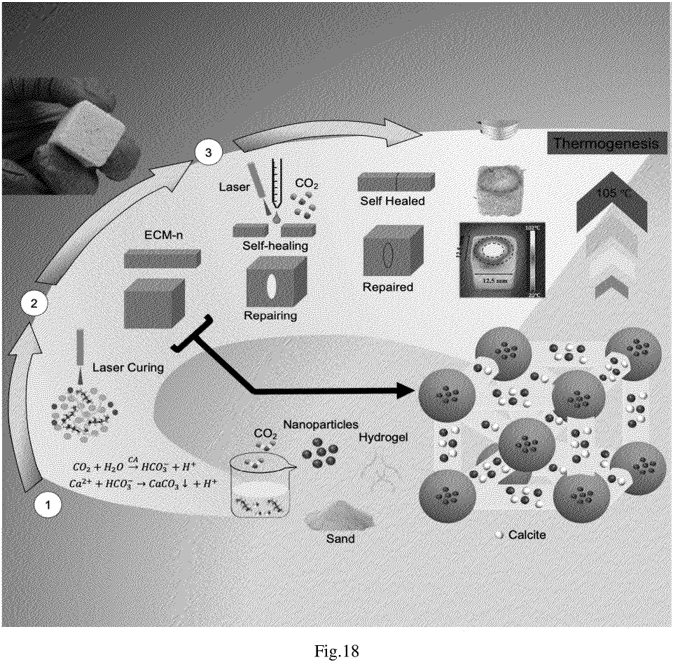

In an oversaturated calcium chloride solution, gelatin scaffold provides a stable platform for crystal nucleation and growth. The solute calcium carbonate then continues to precipitate around bridges which cause the surrounding concentration of calcium carbonate lower than the entire system. The solute CaCO₃ to form solute CaCO₃ and start precipitating at the gelatin surface is denoted as C_{R}. The molar concentration of crystals in the solid mineral is represented by Cᵣ. The molar concentration of CaCO₃ in the solution right around the solid mineral is C₀, which is very low. The dissolution of calcium carbonate is difficult since its solubility is only 13 milligrams per liter. The concentration profile is shown in FIG. 17A. Three defined concentrations follow a relationship written as Cᵣ > C_{R} » C₀. Now, the number of molecules CaCO₃ (dN) that are moving toward the interface to form the mineral bridges are calculated using the Fick’s first law within a time interval, dt, as

$$d N = D \left(2 π \text{} r d z\right) \frac{\partial C}{\partial r} d t$$

where, D is the diffusion coefficient, dz is the length of element along the bridge’s direction, is the distance from the center of the lattice beam and C(r,t) is the instantaneous concentration of the solution.

For the mineral bridge interface to advance a distance dr within a time interval dt, the change in the number of solute CaCO3 molecules within the mineral bridge is written as

$$d N = \left({C}_{r} - {C}_{0}\right) \left(2 π \text{} r d z\right) d r$$

By equating Equations 2 and 3, the following equation is obtained

$$\frac{d r}{d t} = \frac{D}{{C}_{r} - {C}_{0}} \frac{\partial C}{\partial r}$$

The

$$\partial C / \partial r$$

is further estimated by a simplified linear concentration profile as shown in FIG. 17B as:

$$\frac{\partial C}{\partial r} = \frac{{C}_{R} - {C}_{0}}{L}$$

Therefore, by equating the molar numbers of CaCO₃ in these two shaded area A and B,

$$π \left({r}^{2} - {R}^{2}\right) d z \left({C}_{r} - {C}_{R}\right) = π \left[{\left(r + L\right)}^{2} - {r}^{2}\right] d z \left(\frac{{C}_{R} - {C}_{o}}{2}\right)$$

L is obtained as follows:

$$L = \sqrt{{r}^{2} \frac{2 {C}_{r} - {C}_{R} - {C}_{0}}{{C}_{R} - {C}_{0}} - {R}^{2} \frac{2 {C}_{r} - {C}_{R}}{{C}_{R} - {C}_{0}}} - r$$

Using the above equations, the growth rate of a mineral bridge is derived as

$$\frac{d r}{d t} = \frac{D \left({C}_{R} - {C}_{0}\right)}{\left({C}_{r} - {C}_{0}\right) \left(\sqrt{{r}^{2} \frac{2 {C}_{r} - {C}_{R} - {C}_{0}}{{C}_{R} - {C}_{0}} - {R}^{2} \frac{2 \left({C}_{r} - {C}_{R}\right)}{{C}_{R} - {C}_{0}}} - r\right)}$$

and since C₀ is negligible, it is further simplified to

$$\frac{d r}{d t} = \frac{D {C}_{R}}{{c}_{r} \left(\sqrt{{r}^{2} \frac{2 {C}_{r} - {C}_{R}}{{c}_{R}} - {R}^{2} \frac{2 \left({C}_{r} - {C}_{R}\right)}{{c}_{R}}} - r\right)}$$

If the mineral bridge thickness is defined as H = r - R, Equation 9 can be rewritten as:

$$\begin{matrix}\frac{d \left(H / R\right)}{d \left(D t / {R}^{2}\right)} = \\ \frac{1}{\frac{{C}_{r}}{{C}_{R}} \sqrt{{\left(H / R + 1\right)}^{2} \left(\frac{2 {C}_{r}}{{C}_{R}} - 1\right) - \left(\frac{2 {C}_{r}}{{C}_{R}} - 2\right) - \frac{{C}_{r}}{{C}_{R}} \left(H / R - 1\right)}}\end{matrix}$$

The initial condition is H( t = 0) = 0. Now, if we set C_{r/}C_{R} = α, H/R = Y, and Dt/R² = X, therefore:

$$\left[α \sqrt{{\left(Y + 1\right)}^{2} \left(2 a - 1\right) - \left(2 a - 2\right)} - a Y - a\right] d Y = d X$$

Finally, by setting the boundary condition, when t = 0, the X = 0, and integrating Equation 10 from 0 to X:

$$\begin{matrix}\frac{a \left(a - 1\right)}{\sqrt{2 a - 1}} \left\{\left[\left(Y + 1\right) \sqrt{\frac{2 a - 1}{2 a - 2}} \sqrt{\frac{2 a - 1}{2 a - 2} {\left(Y + 1\right)}^{2} - 1} - ln \left(\sqrt{\frac{2 a - 1}{2 a - 2} {\left(Y + 1\right)}^{2} - 1} + \left(Y + 1\right) \sqrt{\frac{2 a - 1}{2 a - 2}}\right)\right] -\right) \\ \left(\left[\frac{\sqrt{2 a - 1}}{2 a - 2} - ln \left(\sqrt{\frac{1}{2 a - 2}} + \sqrt{\frac{2 a - 1}{2 a - 2}}\right)\right]\right\} - α \left(\frac{{Y}^{2}}{2} + Y\right) = X\end{matrix}$$

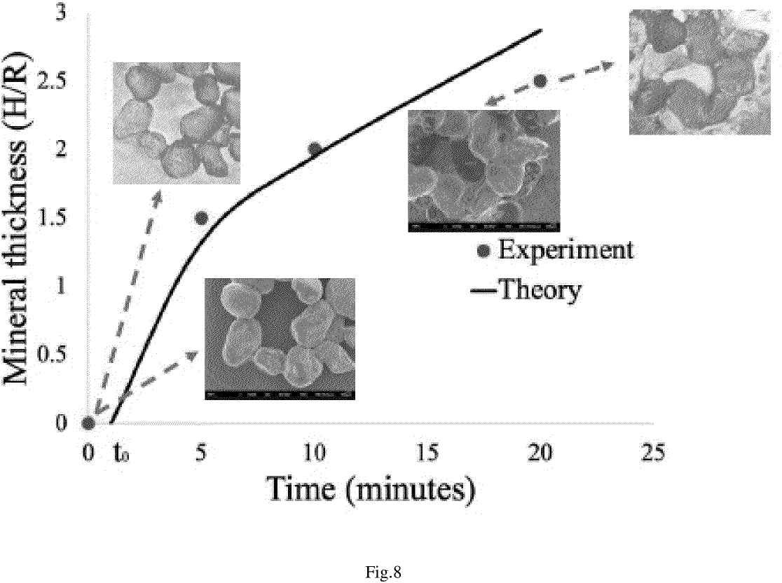

Therefore, crystals start to precipitate in a few seconds, thus the initial time t₀ cannot be equal zero. The experimental parameters assumed: R = 200 µm, α = 4.8 and D = 1.6 × 10⁻⁹ m²/s. The mineral bridge thickness as a function of time is plotted in FIG. 8. The experiment results agree with the presented model.

### Example 11: Reinforced ECM- Tannin Modification

The 0.8% by sample weight of tannin were added to the ECM. This value is significantly higher than the regular ratio in gelatin system modification to achieve a stronger crosslinking. The gelatin-tannin systems can form more and stronger bonds at a faster rate than gelatin systems. However, the performance of crosslinking bond in compression is not as good as in tension. The powdered wine tannin from Midwest Homebrewing and Winemaking Supplies. Inc was selected. 28% by gelatin weight of tannin was manually mixed with gelatin and sand particles and stirred for two minutes. Calcium carbonate solution was prepared in similar fashion described for prior experiments and heated up to 35 C. The matrix was then poured in the cubic silicon mold and 7 mL solution was pipetted on each cube. The samples were then desiccated before conducting the compression test.

### Example 12: Catalytic Performance

CA is the fastest known enzyme with a high rate of catalysis of CO₂ in a diffusion-controlled process. The method of creating ECM is based on CA catalyzing the rapid precipitation of CaCO₃ to create mineral bridges that connect the sand aggregates in two separate steps: CA first catalyzes the reversible hydration of carbon dioxide to bicarbonate (Equation 13) which then reacts with calcium ions in the solution to precipitate CaCO₃ (Equation 14). Synthetic CA analogs mimic the CA reaction. However, the synthetic analogs may be less efficient and would have to be used at higher concentrations to achieve similar results.

The efficiency of the reactions depends on four key factors: (1) the concentration of calcium availability of nucleation site. The catalysis by CA enzyme shows a high biomineralization efficiency where the calcite crystals (CaCO3) self-assemble into a sand-gelatin matrix to establish ‘bridges’ between the sand particles. Gelatin serves here as a harmless and odorless scaffold, which gains strength by physical crosslinking after dehydration. It can be regarded as a carrier of crystal, connecting the whole microstructure system.

$${\text{CO}}_{\text{2}} \text{+} {\text{H}}_{\text{2}} \text{O} {\to }^{\text{CA}} {\text{HCO}}_{\text{3}} {}^{\text{-}} \text{+} {\text{H}}^{\text{+}}$$

$${\text{Ca}}^{\text{2+}} \text{+} {\text{HCO}}_{\text{3}} {}^{-} \to {\text{CaCO}}_{\text{3}} {↓}^{\text{+}} {\text{H}}^{\text{+}}$$

There is enough ambient carbon dioxide in the air to drive the main chemical reaction prescribed earlier. While the reaction between carbon dioxide and water is reversible, both sides of the reaction proceed simultaneously to achieve a “dynamic equilibrium”, which hinders the precipitation of the calcium carbonate crystals. In this process, carbon dioxide dissolves in water to form carbonic acid, while chloride ions, from calcium chloride, produce hydrochloric acid, and as the reaction proceeds, calcium carbonate and hydrochloric acid are formed. Buffer is often added to prevent a drop in pH and enhance calcium carbonate crystal precipitation. According to Le Chatelier’s principle, the balance moves in the direction of reducing hydrogen ions. In other words, the direction is moving toward producing weak acid molecules. Conversely, when a weak acid is added to a strong acid salt solution, since the strong acid has no ionization equilibrium, the change in the concentration of hydrogen ions in the solution will not create strong acid. Therefore, when the solution is proportioned, to make the calcium carbonate crystal precipitate constantly, a tris buffer is added into the reaction. The buffer solution composed of the weak acid “HA”, and own salt “NaA”.

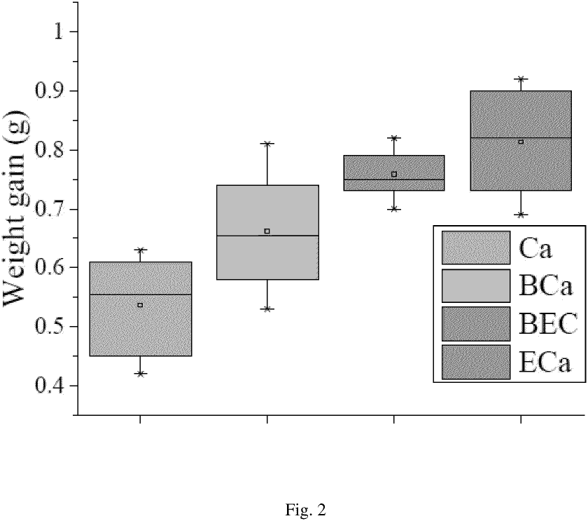

The buffer solution contains enough alkali “A⁻” ions that used to buffer the strong acid in the solution. When a certain amount of strong acid is added to the solution, H⁺ ions are basically consumed by “A⁻” ions, the pH value of the solution is constant. Thus, the calcium carbonate crystals can precipitate successfully. As a first step in developing the material, the efficiency of CA was quantified by measuring the weight gain from the precipitated crystals produced in the enzymatic reaction. The results of weight gain of four different solutions are presented in FIG. 2. ‘Ca’ represents the aqueous solution that includes only the calcium source; ‘BCa’ represents the base and calcium source solution; ‘BEC’ represents base, CA enzyme and calcium source solution; ‘ECa’ represent the system of sand slurry without gelatin, in which only CA enzyme and calcium source were added into solution. Within in a same time range, the ECa sample obtained the highest average weight gain about 0.82 g, which higher than the BEC samples about 0.07 g, and significantly higher than Ca samples about 0.24 g. The results indicate that the carbonation by enzyme catalyze is efficient and the calcium crystallization ability in ECa is the highest in the group. It should be noted that the weight gain is not equal to the amount of precipitated crystal precipitation but indirectly reflects the catalytic ability of the enzyme to convert carbon dioxide. The weight gain in every solution is equal to the quantity of absorbed CO₂, which is used to calculate the weight of precipitated calcium carbonate based on Equations 13 and 14. The catalytic efficiency K_{cat} of CA at 25° C. and pH = 9 is around 106 rec/s, which defined as the CO₂ hydration turnover rate, in other words, is the maximum number of substrate molecules transformed into the product by a single CA in one second.

TABLE 1

A comparison of the CA enzyme catalyze activity in experiment and theory

| K_{cat} =10⁵ rec/s | Weight gain (g) | CaCO₃ (g) | CO₂ (Molecules) |
|---|---|---|---|
| Experiment | 0.82 | 1.86 | 1.12*10²² |
| Theory | 2.56 | 5.80 | 3.49*10²³ |

The theoretical and experimental results are compared in Table 1. The theoretic result for CO₂ molecules is 3.49 \*10²³ and the experimental molecules quantity of CO₂ molecules is 1.12 \*10²², considering the experimental error and the effect of carbon dioxide on pH (K_{cat} will change by pH), the experimental results are well in agreement with the predicted results in the ambient temperature regime, and the enzyme indeed performed an improvement in carbonation.

Comparing the BCa samples in FIG. 2 with Ca samples, it was observed that more crystals precipitated after adding a base reagent to the solution. From Equation 13, the hydroxide ions neutralize the hydrogen ions in the solution and push the reaction forward. The urease uses the nitrogen source, urea, to produce hydroxide ions to increase the solution pH, causing calcium carbonate to precipitate from the calcium ions in the solution.

The CA mediated calcium carbonate precipitation was compared to the urease method, and the comparisons included mechanical properties and structure formation. The calcium carbonate without sand formed by the urease slurry is a non-uniform crystal structure, however the calcium carbonate from the CA slurry is organized and uniform in layers. The calcium carbonate in the CA method adheres to the sand particles and forms an organized, uniform layered structure, most likely due to the faster production of the precipitates decrease the mobility of solid particles. Additionally, in terms of mechanical properties, the compressive strength and tangent modulus of the CA samples outperform urease samples. These experiments indicate that the CA method is more effective in mineral precipitation and the assembly of sand slurry construction materials.

### Example 13: Microstructural Characterization

To understand if the composition and morphology of ECM is influenced by the presence of the CA enzyme, four different compositions were used to assess the quantity of mineral precipitation, mineral distribution, structural arrangement, and bridge size different at high pH, no CA enzyme and no calcium source. The control ‘GL’ (Gelatin) samples were created with the same media as the ECM (CA + Gelatin + Ca²⁺), except for the CA enzyme and calcium source. The ‘BGE’ (Base + gelatin + CA + Ca²⁺) represents a high pH control group, where higher pH helps to produce more partials of calcium carbonate. The ‘GCa’ (Gelatin + Ca²⁺) samples demonstrate the effectiveness of the CA enzyme in crystal precipitation and microstructure, which fabricated with the gelatin and calcium source.

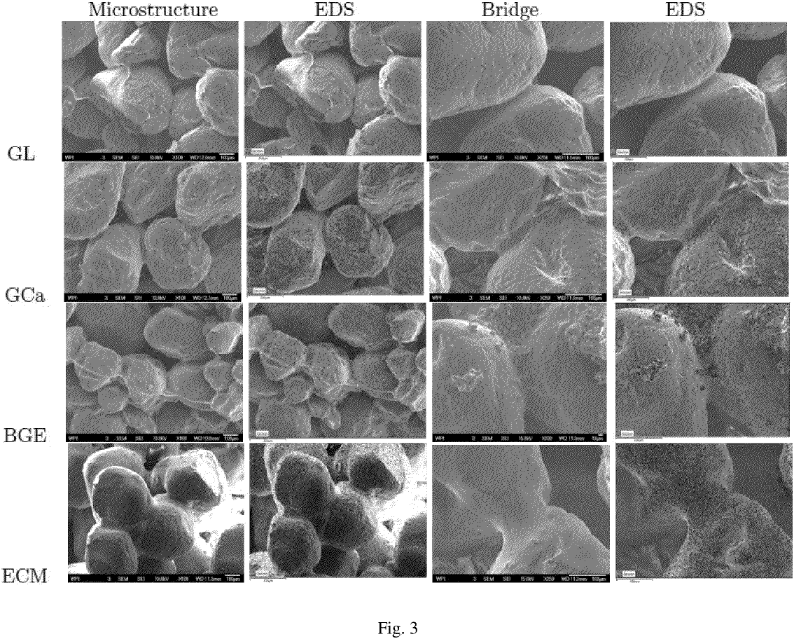

Compared to the other three groups, the structure of ECM is denser and more organized. The surfaces of GL and GCa samples are smooth, and their bridges in some domains are too short or too fine. The mineral bridges in BGE are stronger, but the overall arrangement of structure is inordinate. During the preparation of ECM, most of the calcium carbonate crystals were trapped or covered in the gelatin and formed a bridge, and it is difficult to observe the crystal distribution of the surface directly through SEM. The samples were then analyzed by Energy Dispersive X-Ray Spectroscopy (EDS). EDS can qualitatively determine and locate the crystals by the content of calcium. The results of the distribution of Ca2+ from EDS analysis are shown in FIG. 3. There is no calcium observed in the EDX maps of the GL samples since no calcium was added. EDX revealed a dense distribution of calcium in ECM that contributes to the broader and wider bridges which cover a large portion of the surrounding sand particle surfaces. In samples GCa and BGE, only a small amount of calcium is distributed on either sand surfaces or bridges. FIG. 4A and FIG. 4B display a close view of the bridging mechanism between ECa (CA+ Ca2+) and ECM samples. Although the calcium carbonate crystals form a decent bridge network to bridge the sand particles, the size of the ECa bridge (around 80 m) is smaller than the ECM (150 m), which means that the gelatin scaffolding enhance and extend the bridges. The crystals align closely in gelatin resulting in an organized and dense structure that establish a mechanism for the enhancement of the mechanical properties of the ECM.

The fracture mechanism of ECM relies on the bridging connections among the sand aggregate. FIG. 4C and FIG. 4D show ECM sample after mechanical testing, displaying the cracks that propagate in the center of the bridges in the transverse direction. FIG. 4D shows a typical fractured surface at the crack tip region where a 150 m diameter facture surface is exposed. FIG. 4E shows sand aggregates were detached from matrix; this is the other major fracture mechanism after bridge failure and was found within the sand gelatin system. However, this mechanism occurs more often in the case of self-healing cycles.

### Example 14: X-ray Diffraction (XRD) and FT-IR Analysis

To examine the crystallinity and chemical composition of the ECM enzyme product, powder X-ray diffraction (pXRD) and FT-IT were performed on a Bruker AXS D8 Focus (Bruker, Billerica, MA, 102 of 190 USA) at 25° C., and the pXRD spectrum used a CuKa radiation source at 40 keV and 40 mA from 20 to 90 of 2 with a step size of 0.100, against the baseline and Bruker Optics Vertex 70 equipped with a Specac Golden Gate Diamond Single Reflection ATR element (Bruker, Billerica, MA, USA). The results ( FIG. 12 and FIG. 13) verify that the crystallinity of the enzyme product is mostly calcite.

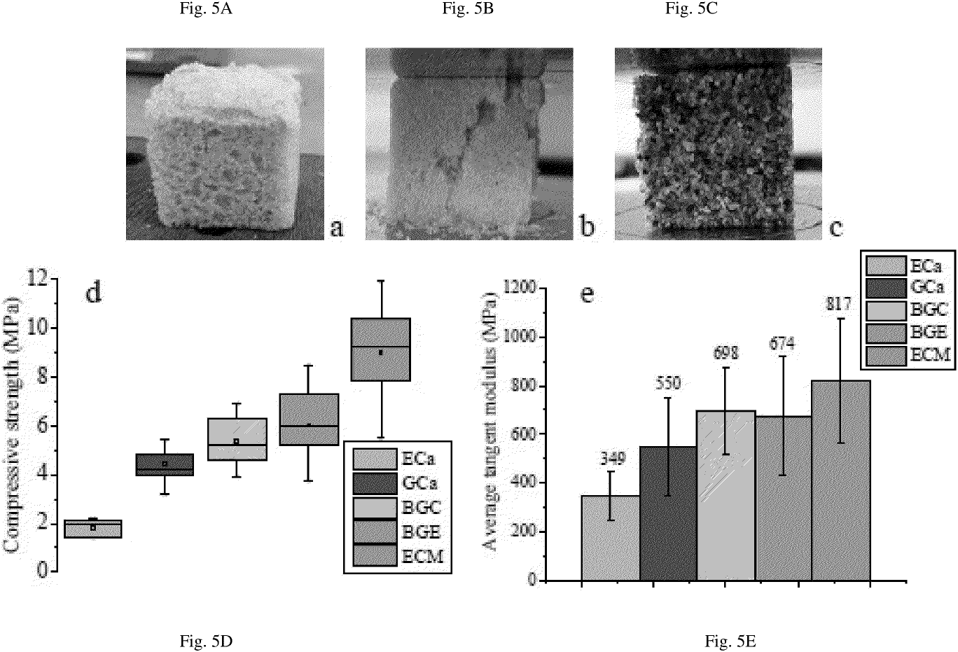

The mechanical experiments were focused on the compressive strength, tensile and fracture properties of ECM with reference groups. Compressive tests and three-point bending tests were performed to study the mechanical performance of the proposed enzymatic construction material. Five different groups of sand slurry samples were prepared and termed: ECa (CA + Ca²⁺), GCa (gelatin + Ca²⁺), BGC (Base + Gelatin + Ca²⁺), BGE (Base + Gelatin + CA + Ca²⁺), and ECM (CA + Gelatin + Ca²⁺). It is noted that above samples incorporate the calcium source. The compressive strength and elastic moduli are presented in FIG. 5A- FIG. 5E.

The main function of a construction material such as concrete is compressive strength. The compressive strength of the concrete mixture depends on the properties of the aggregate and cement mortar matrix. As a potential building material, ECM also possesses its own ‘aggregate’ and ‘mortar matrix’, and its mechanical properties are similarly a function of the strength of sand and mineral bridge. The results in FIG. 5A show that gelatin as scaffold in GCa can increase the compressive strength of the sand slurry material ECa. However, in comparing GCa with ECM, an average strength of 4.5 MPa is not noticeable. The data show that the ECM performs the highest compressive strength and elastic modulus.

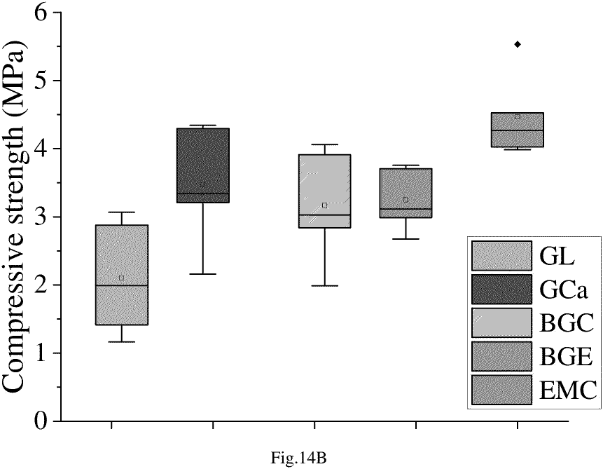

The average compressive strength of the ECM samples is 9 MPa, which is twice as high as the GCa specimens, 4.7 times the ECa specimens, and significantly higher than the base amended specimens of BGC & BGE (FIG. 5D). The elastic modulus of ECM is higher than other specimens, which means the elastic deformation under the same external force is smaller. It can be observed from EDS-SEM images in FIG. 3 that the size of crystal bridges in the ECM on average is about 150 m wide and 50 m long. Also, the calcium carbonate crystals in ECM are distributed more uniformly. Comparing the EDX maps of ECM samples with BGE and BGC samples, a significant amount of calcium was observed on the ECM bridges. Therefore, comparing with the structure and mechanical properties of the other three groups, it can be deduced that the crystal bridges are the principal strengthening and toughening mechanisms in these heterogeneous materials. It is noted that the compressive strength of ECM is more than two times of standard cement mortar (with a specific strength of 3.5 MPa). The sand slurry cubic samples with coarse aggregates were also fabricated (FIG. 5C), and their compressive strength is presented in FIG. 14. The coarse sand slurry ECM performs a higher average strength than high pH BGE samples by about 31%, and control gelatin samples GCa by about 17%. CA enzymes play the same role in both fine and coarse sand samples by increasing the rate of crystal precipitation within a fixed time, and consequently, strengthening the samples. However, the maximum size of the crystal bridges is limited by the amount of calcium, which prevents the increase in strengthening in coarse aggregates above a certain threshold. The maximum size of bridges limits the challenge of bonding large sand particles, which results in relatively lower strength for coarse aggregate samples than for fine aggregate samples. Since the size of the crystal bridges in the fine aggregate samples is comparable to the size of the particles, the forces are more evenly distributed in the microstructure of the materials, and hence, higher overall strength and fracture energy.

### Example 15: Tensile Test

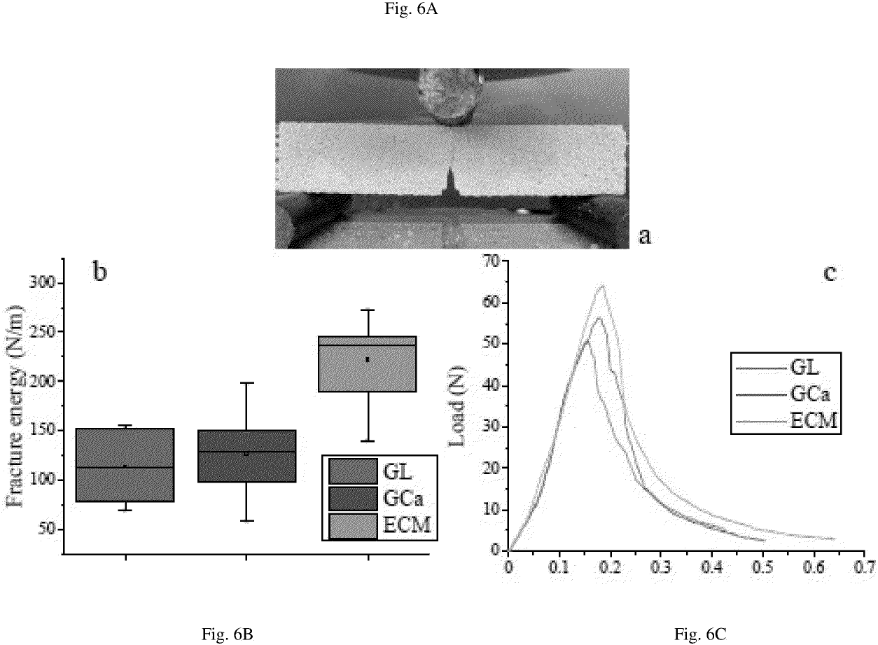

Fracture energy is an important mechanical property of building materials since the propagation and control of cracks are highly related to the serviceability and durability of materials. The single edge notch bending (SENB) test of ECM beam samples, shown in FIG. 6A, were conducted and the results of the fracture tests are presented in FIG. 6B and FIG. 6C. Fracture energy and load displacement curves reflect the excellent mechanical properties of ECM. FIG. 3 EDS maps show that the bridges are mainly calcium carbonate crystals incorporated within gelatin scaffold to bridge the sand particles. Fracture surfaces in FIG. 4A-FIG. 4E also show the typical fracture mechanism in ECM by particle debonding and bridging failure. Hence, the toughening mechanism is mainly undertaken by mineral bridges. Therefore, an ECM with wider and longer bridges can exhibit excellent tensile properties. The fracture energy results indicated that applying CA enzyme method significantly increases the fracture energy by about 100% compared with GL and by about 77% compared with GCa. The average ultimate load of ECM samples is also higher than GL samples by about 27% and GCa samples by about 16%. The fracture and bending tests of coarse sand slurry ECM are illustrated in FIG. 15A- FIG. 15C. The fracture energy of coarse sand slurry ECM is higher than control ‘GCa’ by about 38%, and higher than high pH samples (BGC) by about 120%. There is no other method that creates a structural sand slurry material with similar compressive strength and fracture energy.

In the sand slurry materials, calcium carbonate crystals bridges are the critical element in providing compressive strength and play an interlocking role in the toughening mechanism. However, the polymer scaffold provides the main toughening system. Comparing the ECM beam fracture specimens with two control “GL” and “GCa” groups, it was observed that the fracture energy and ultimate tensile loads are promoted by CA enzymatic catalysis, and aggregate type and size can also affect these material’s strength and fracture energy. However, similar trends were observed in the examples on coarser aggregate ECM. In coarse sand ECM samples, the mineralized gelatin matrix has a significant toughening role. The control groups without CA treatment (GCa) show lower fracture energy. Under high pH conditions, CA enzyme catalysis has a more negligible effect on the fracture energy, especially in coarse sand slurry samples ( FIG. 15A- FIG. 15C). Although more crystals were precipitated, the impact of crystal quantity on the toughness of the coarse sand ECM may be less than other factors. In FIG. 15A- FIG. 15C, more crystal precipitation does not increase the toughness of the material in the case of high pH. SEM images show that the calcium-gelatin matrix bridges of ECM are wider and longer than that of non-CA enzyme samples GCa, which plays an essential role in the toughening mechanism in these materials where fracture initiates on the bridges in the high stress regions. However, since the mortar on the macro-scale is uneven, there may be other mechanisms to strengthen and toughen the specimens. The interfacial fracture toughness between the crystal bridges and the sand surface, which a function of the surface roughness of the sand particles can also affect the overall strength and toughness of these materials.

Although, previous publications state that a high pH condition can benefit the carbonation, overall performance of samples with the high pH preparation are not as well as ECM samples. Within a limited reaction time, adding base reagents generate a portion of the calcium hydroxide with calcium carbonate in the precipitation. Calcium hydroxide consists of one calcium cation and two hydroxide anions at the molecular scale, and calcium carbonate consists of one calcium cation and one carbonate anion, in which both calcium hydroxide and calcium carbonate are non-polar. Most of the calcium carbonate (calcite) possess a cubic structure at room temperature, which creates a more stable and stiff structure in all directions. However, calcium hydroxide crystals have a plane structure at room temperature, which are weaker. The elastic modulus and strength of calcium carbonate is about 70 GPa, which is higher than those of calcium hydroxide at about 48 GPa, respectively. Therefore, the calcium hydroxide crystal in the bridge results in inferior advantage on both compression and tension.

### Example 16: Crystal Growth Modeling

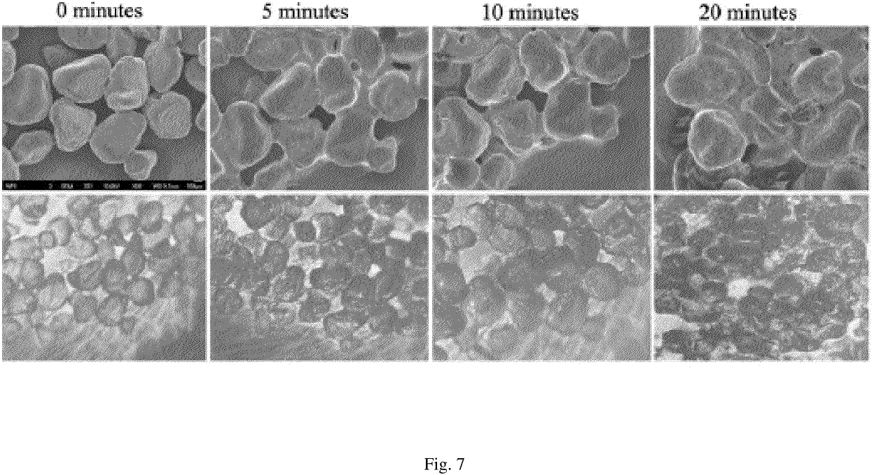

Understating the crystal nucleation and growth are of prime importance in determining and predicting the physical properties of ECM. Hence, the optical and electron microscopy were extensively utilized to study the time lapse of crystal growth in ECM samples. In FIG. 7, the formation of calcium carbonate crystals on the sand-gelatin system surfaces are presented using SEM and optical images. In the ECM, the rough surface of gelatin scaffold and sand provides numerous sites for the nucleation reaction of calcium carbonate in solution. With CO₂ as the foreign substance in solution, the crystal growth method is defined by heterogeneous nucleation, thus, the energetic barrier problems associated with preliminary nucleation are inevitable. Here, carbonic anhydrase reduces the activation energy for the reaction barrier. It is clearly observed from the images that the calcium carbonate crystals are formed immediately under the enzymatic catalysis. Crystal growth then results in gradual expansion of the cross-sectional area of the bridges and the formation of the bridging network between sand particles. In about 20 minutes, most geometrical voids were filled, and the structural system shows strong integrity. To further verify the processes of crystal growth, additional SEM and optical images of the bridging network are presented in FIG. 15A- FIG. 15C.

Crystal growth in ECM is diffusion-controlled mechanism. The details of the crystal growth process on the sand-gelatin system are presented in Crystal bridge growth model, using the diffusion relationships by Fick’s First Law. The models were analytically solved to verify the experiment results. The results of the crystal growth modeling framework are presented as the average thickness of the mineral bridges as a function of time in FIG. 8. The theoretical equations are established for crystals grow on the square cross-section beam. The inventors here envision that the calcium carbonate crystals growing on the gelatin of ECM system is the same as the growth pattern on the polymer. The initial gelatin is considered the polymer beam, and the volume change of the beam is the result of crystal growth subsequent.

### Example 17: Self-Healing Properties

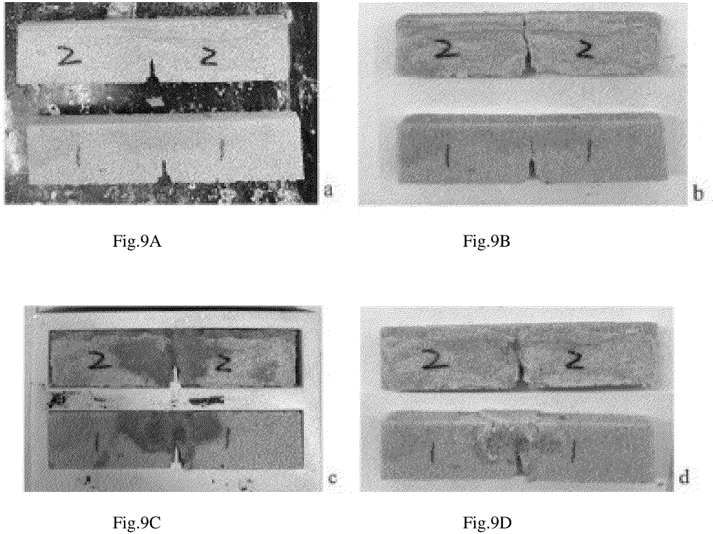

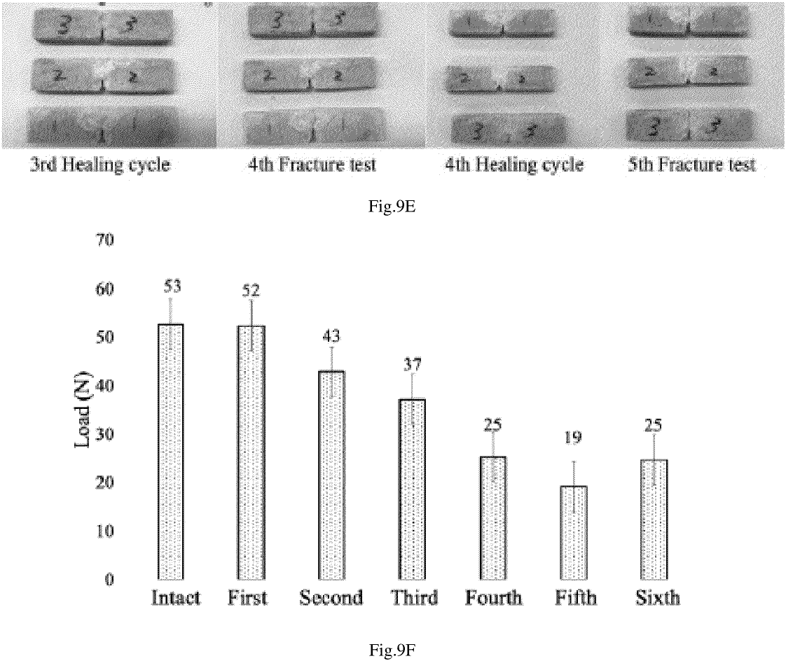

To investigate the self-healing and reconstruct ability of the ECM, it is necessary to simulate the healing process through the multiple cycles. For this purpose, an experimental procedure utilizing the three-point bending test was developed. The fracture strength of the beam specimens in each cycle was measured to evaluate the extent of healing in the ECM. In each healing cycle, the fractured samples were placed in a silicon mold and treated with a trace amount of enzyme + calcium solution on the crack surface region ( FIG. 9A and FIG. 9B). Pure CO₂ gas was then introduced on the crack surface for 10 minutes. The mineral precipitation occurred predominantly near the crack wake of the specimens. This procedure can be observed as the liquid film on the surface of the samples in FIG. 9C. Healed samples were then fully dehydrated in the oven and demold (FIG. 9D). Three-point bending fracture tests were then again conducted. The prescribed steps were repeated for each cycle and the properties of the healed samples were studied (FIG. 9E). Herein, the mechanical property of the original sample is termed “Intact,” the first repaired sample is termed “First,” and the second repaired sample is termed “second”, etc.

The results show that the average ultimate loads are similar in intact and first cycle samples at about 53 N ( FIG. 9F). Six samples were tested in each group, and initially, the average maximum load of the second cycle samples decreased to 43 N. This is an 18.8% decrease from first to second cycle, a 13.9% decreasing from second to third cycle, and 35.1% decrease from third to fourth cycle. After the fourth cycle, the ultimate load tends to be stable at about 23 N, which reduce from the intact cycle by 52.8%. The results clearly show the ECM beam can reconstruct after six times cycling damage, which shows a self-healing property.

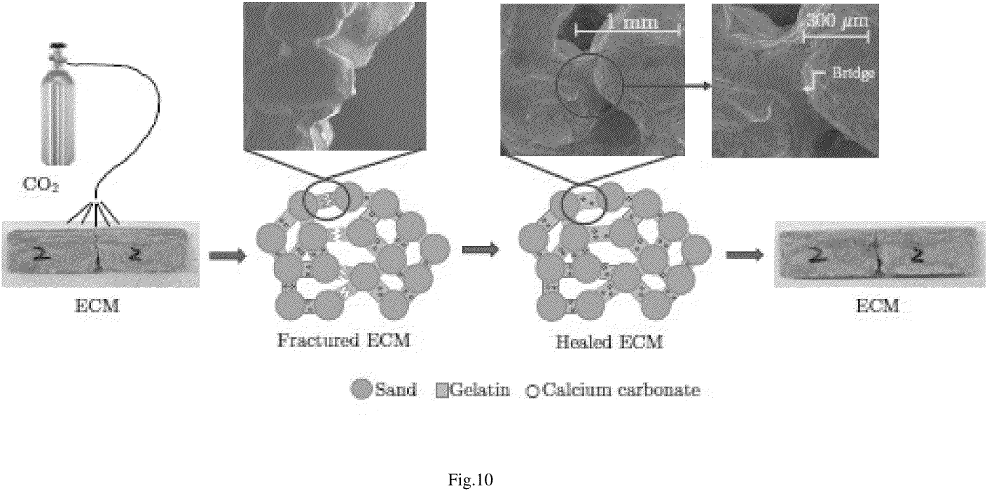

The method clearly demonstrates the damage and healing process of ECM. The entire process only requires a trace amount of calcium source as the filling material. The healing structural materials with a significantly large defect require addition of some filling materials which is also required in all other self-healing methods such as MICP and Living Building Materials (LBM)s. Furthermore, through the catalysis of carbonic anhydrase, the carbon dioxide in the air can be involved in the self-healing reaction; thus, this process also plays a small role in carbon dioxide sequestration during healing. The results in FIG. 9F show that the average maximum load is decreasing from the second healing cycle with a relatively stable decline up to the fourth cycle. From the fourth cycle of healing, the average maximum load plateaus to about 23 N, which is half of the intact property. Self-healing is the reconstructed structure of crystal-gelatin on the substrate perpendicular to crack surfaces that can establish effective crystal bridges as it can been seen in FIG. 10. The SEM analysis of the samples shows that the major fracture mechanism is the failure of mineral bridges. In the self-healing process the bridges are reestablished after the application of CO₂ ( FIG. 10).

It is here envisioned that the entire structural system on the fractured surface was not fully destroyed after the first fracture and the original gelatin-calcium carbonate crystals remained on the surface of the exposed sand grains. From second healing cycle, the gelatin on the surface of the sand is further dissolved by the aqueous solution, changing the structural integrity at the crack surface. The reason for a stable maximum load after the fourth healing cycle is that top layer sand on the fracture surface exposed without gelatin and those sand particles bridge to the calcium carbonate crystal directly. This also clearly demonstrates the efficiency of the method. It must be noted that the titration solution will only penetrate from one side to the bottom which leads the gelatin to concentrate in the lower layer, which in turn leads to the creation of nonuniform crystal bridge structure as the number of healing cycles increases. The data in FIG. 5D and FIG. 5E shows that the dehydrated gelatin scaffold significantly contributes to the compressive strength of ECM, so its deterioration weakens the strength of the specimens as number of healing cycles increases. Moreover, gelatin aging could also occur during multiple healing cycles.

### Example 18: Reinforced ECM

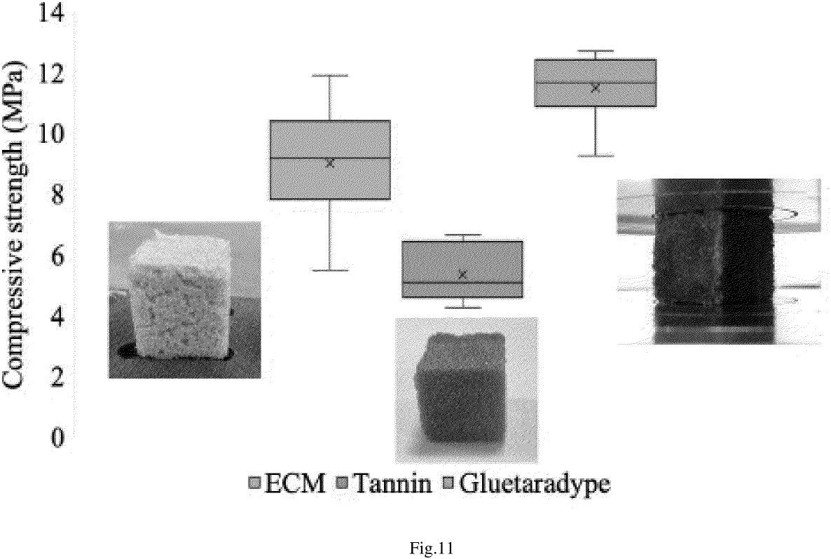

To enhance the physical properties of gelatin, crosslinking agents such as: glutaraldehyde, genipin, and microbial transglutaminase are applied. Here, glutaraldehyde was chosen as the ECM crosslinking agent which is by far the most widely used with gelatin, due to its accessibility, low cost and high efficiency of collagenous material stabilization. Only very low concentration of glutaraldehyde (1% by gelatin weight) is sufficient to obtain a 100% degree of crosslinking and 20 times increase in Young’s modulus with respect to un-crosslinked gelatin film. The crosslinking of gelatin with glutaraldehyde involves the reaction of the free amide groups of the lysine or hydroxylysine amino acid residues in the polypeptide chain with the aldehyde group of glutaraldehyde. As the degree of crosslinking increases, the thermal and mechanical properties of gelatin are also increased. Tannin is used as additive to improve the mechanical, thermal, and moisture absorption behavior of the gelatin-based adhesives. It was shown that the bond strength (tensile) was increase by 16%. The compressive strength of results of glutaraldehyde were compared to Tannin in ECM. FIG. 11 displays the compressive strength of glutaraldehyde modified ECM at around 11.5 MPa, which is 28% higher than the ECM. Meanwhile, tannin modification (27% by gelatin weight) of ECM samples failed to reinforce the ECM structure.

Although glutaraldehyde is an irritant, thousands of successful bio-prosthetic implants have demonstrated that glutaraldehyde cross-linking is clinically acceptable, reducing its cytotoxicity when used at very low concentration.

### Example 19: Laser-Induced Curing of ECM-n

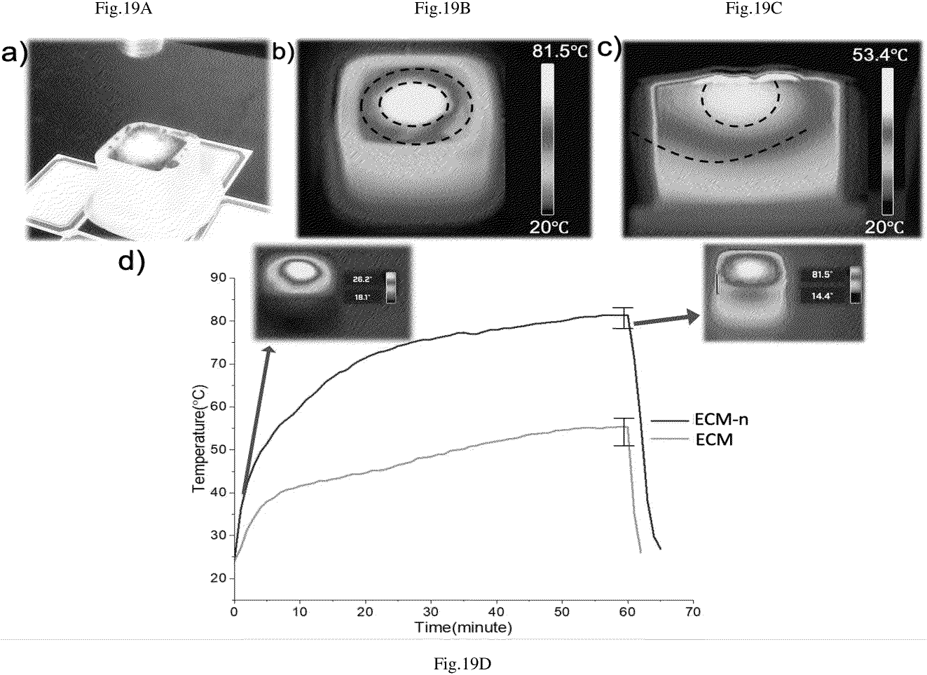

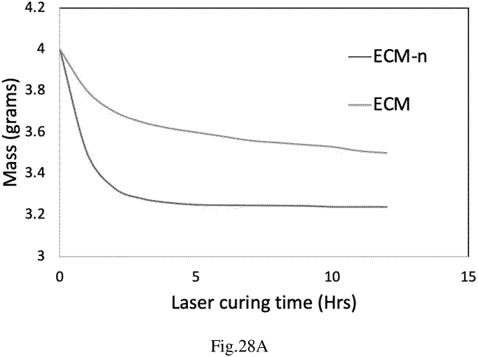

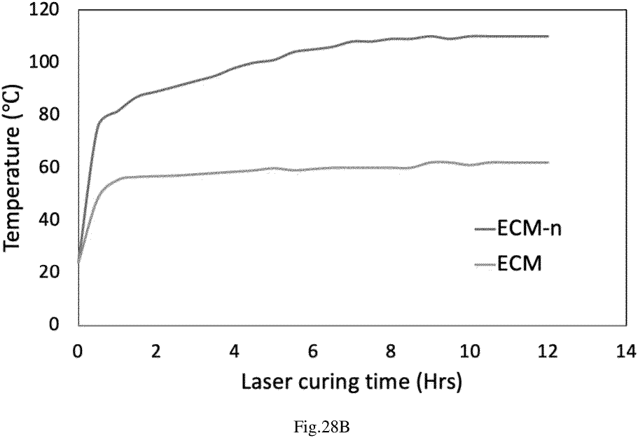

To verify the effect of nanoparticles on ECM curing rate, the 12.5 mm cubic ECM-n (ECM with 0.1% iron oxide nanoparticles) and ECM were fabricated using the same method and subjected to the same power laser. Both specimens were cured under a 3 W laser (808 nm wavelength) for 12 hours to obtain a specific degree of dehydration through mass loss evaluation ( FIG. 28A). As shown in FIG. 28B, the maximum surface temperature of ECM-n reaches 110° C. in 12 hours to obtain full dehydration, which shows a stable mass after 9 hours. In contrast, the maximum surface temperature of ECM only increases to 62° C. and maintains the mass loss condition. The surface temperature of ECM-n and ECM within the first curing hour was recorded in FIG. 19A- FIG. 19D. FIG. 19A shows the early curing configuration of a cubic 12.5 mm ECM-n in a silicon mold where the sample was placed under a 3 W continuous wave laser (808 nm) at a 2 cm distance for 60 minutes, while the surface temperatures at the top and side were recorded by a thermal camera for 70 minutes. We find that the maximum surface temperature of the ECM-n sample increases from 26° C. to 81.5° C. (sample: n = 5, median: Med = 81.5, standard deviation: SD = 3), ( FIG. 19B and FIG. 19C). In contrast, the temperature of all ECM samples without nanoparticles never rises above 60° C. (n = 5, Med = 53, SD = 5.7). The temperature distribution is non-uniform, with the maximum temperatures occurring within the center of the laser beam. From the temperature curves in FIG. 19D, the heating rate of ECM-n is ∼twofold higher in the first 20 minutes, the cooling rates of both were similar, reaching room temperature in five and two minutes, respectively, and giving a cooling rate of 11° C./min (n = 5, SD = 0.82) for ECM-n and 15° C./min for ECM (n = 5, SD = 1.63). These data indicate that the addition of nanoparticles does not significantly increase the specific heat capacity of ECM. Due to the low specific heat of nanoparticles, the nanoparticles accelerated curing by photothermal effect.

### Example 20: Heat Released Analysis During the Initial Curing

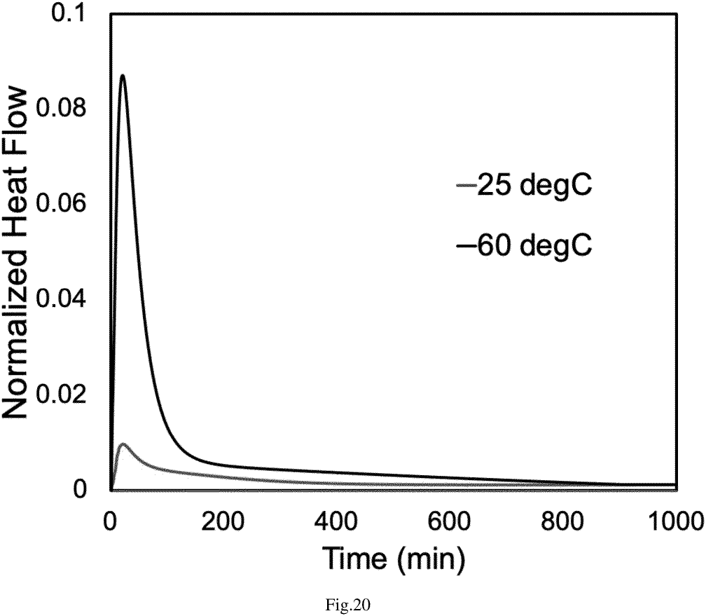

To quantify the early curing kinetics of ECM-n, we used Isothermal Calorimetry (ITC) to understand the relationship between time and heat flow of ECM-n. In FIG. 20, heat flow in ECM-n samples at 25° C. and 60° C. were compared. One heat flow peak was detected at two different temperatures in 30 minutes and both peaks appeared immediately after injecting the enzyme calcite solution, and the peak at 60° C. is more distinct than the peak at 25° C. The intensity of the peak increased with the temperature, indicating that the elevated temperature significantly enhances the degree of dissolution. The higher dissolution of the raw materials at higher temperatures provides more scaffoldings for the following bridging steps, and thus accelerated the early strength development and the final setting of the ECM-n samples.

### Example 21: Laser Heating ECM-n In Low and Room Temperatures

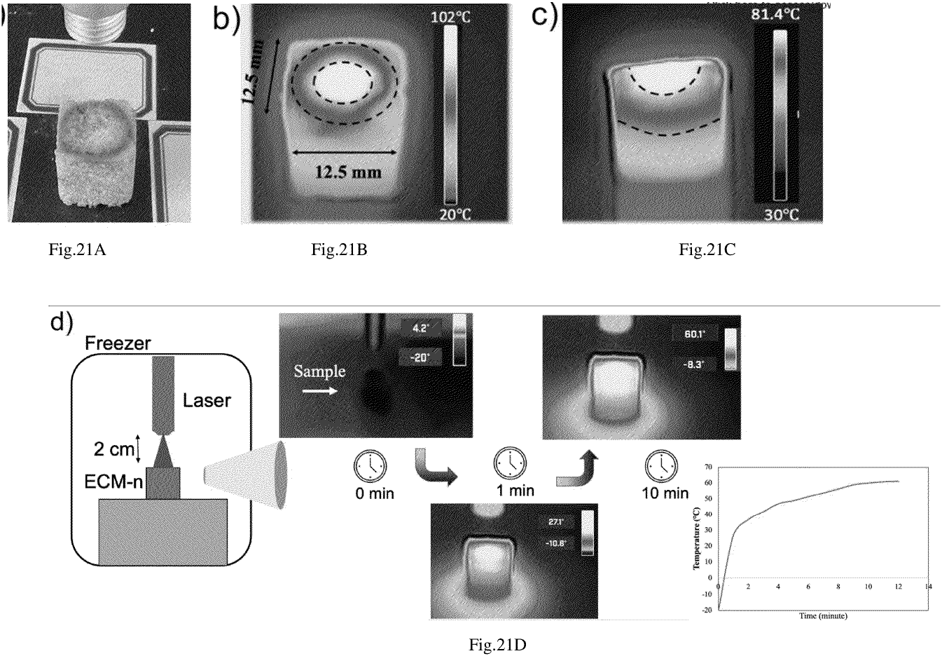

The application of laser heating was also explored on cured ECM-n. FIG. 21A and FIG. 21C demonstrate the photothermal effect on cured ECM-n at ambient temperature induced by a 3W continuous wave laser. FIG. 21A shows the experimental setup. FIG. 21B and FIG. 21C show the top and side views of the contours of temperature for an ECM-n sample subjected to laser heating for about one hour, respectively. For a sample distance of 2 cm from the laser, the peak temperature is concentrated in the center of the sample surface and spreads radially outwards into the surrounding surface region. The results indicated that the maximum temperature of the ECM-n surface increases to 102° C. at room temperature. The influence of heat convection on the side can be observed in FIG. 3C. The temperature profile shows a curve in the form of layers, with the lowest temperature at the furthest position from the heat source.

The photothermal effect of cured ECM-n was also explored at low temperatures. The time sequence of the experiment is presented in FIG. 21D. The sample was stored in a -20° C. freezer to obtain a homogenous temperature on the surface. The schematic on the left shows the experimental setup. The sample was then illuminated in a freezer by the 3 W laser. A thermal camera was exploited to record the temperature of the sample surface under illumination for 10 minutes. At the center of the top face of the sample, the temperature increased from -20° C. to a maximum of 60° C. in 10 minutes. The above findings provide a new path for ECM to be utilized as a thermally controllable construction material.

### Example 22: Thermal Modeling of Laser Heating

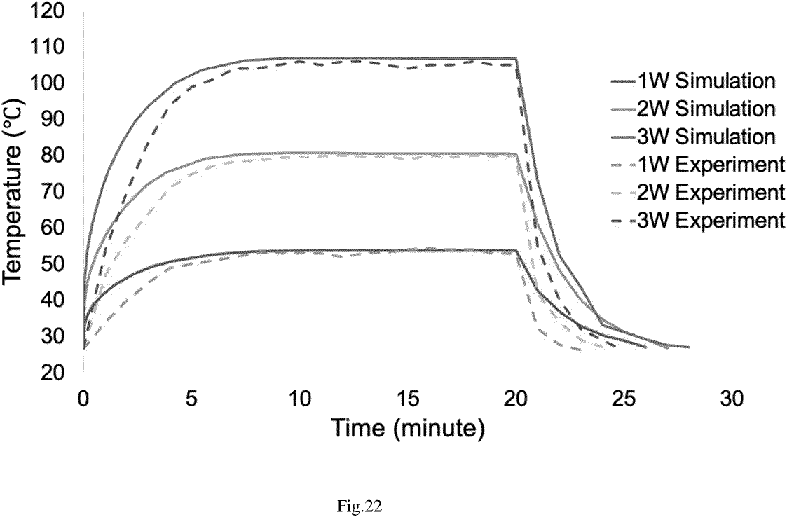

To further demonstrate the thermogenesis ability of the ECM-n, the computational laser heating was modeled using the Finite Element Method (FEM) and the software package COMSOL Multiphysics 6.5 (COMSOL, Inc. Burlington, MA). FIG. 22 presents the maximum temperature as a function of time for an ECM-n sample at three different laser powers. It can be observed that the simulation results are slightly less than the corresponding experimental results, and the normalized temperature profiles are proportional to the laser power.

In the process of heating, the ECM-n by laser, heat transfer happens through three main mechanisms: conduction, convection, and radiation. The static laser beam follows Fourier heat conduction law. The heat distribution within the ECM-n is then determined by the following transient heat transfer equation:

$$ρ {C}_{p} \frac{\partial T}{\partial t} = ∇ ⋅ \left(k ∇ T\right) + α Q$$

where ρ is the density equal to 1660 kg/m³, Cp is the heat capacity of sand equal to 840 J/kg·k, T is the temperature, t is the time, and the thermal conductivity of iron oxide is denoted as k, which is equal to 2.7 W/m·k.

A thermal conductivity parameter was used to represent the iron oxide in this ECM-n model for two reasons: 1) During the dehydration process, the gelatin undergoes a phase change from a gel to a crystalline state, which complicates the modeling process; 2) the iron oxide possesses a higher thermal conductivity than sand and gelatin, which significantly affect the temperature of the system.

The absorption coefficient, α, depends on the object material and the interaction between the object material and the wavelength (808) of the laser, where most models use a constant absorption coefficient by neglecting the influence of incident angle and temperature. To simplify, the absorption coefficient was assumed to be 1, and Q (W/m3) is the laser heat source term. The boundary conditions for Equation (15) at the side of ECM-n are heat transfer by convection, and at the top surface is radiation. The convection (Newton’s law of cooling) in the laser heating process is expressed by

$${q}_{c o n} = h \left({T}_{e x t} - T\right) = - \hat{n} ⋅ - \left(k ∇ T\right)$$

The radiant heat flow rate of the object can be computed based on the empirical formula of Boltzmann’s law by

$${q}_{r a d} = ε σ \left({T}_{a m b}^{4} - {T}^{4}\right)$$

Heat convection always is transferred by gas or liquid media. The air is the major media in the convection, for simplicity, the heat convection coefficient is considered to be uniformly distributed, and equal for all surfaces of the boundary, where, h, the natural air heat convection coefficient is 25 W/m2·k. ε, the emissivity of sand is estimated to be 0.95.[19] σ is the Stefan-Boltzmann constant, and [symbol] the direction vector. Text and Tamb are the medium air and room temperatures, respectively, where both are assumed to be 300 K. For a continuous wave laser mode, the fundamental mode of the Gaussian beam is generally preferred and the Gaussian heat source is provided, accordingly. The rate of heat generation by the Gaussian profile of a transverse model optical intensity of order n can be given by

$$Q \left(x , y\right) = p f ∗ f \left(x , y\right)$$

Here, the laser power intensity (W/m2) can be expressed by

$$p f = \frac{P}{π ⋅ {r}^{2}}$$

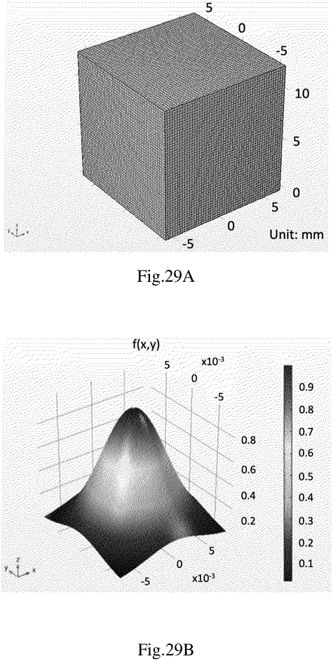

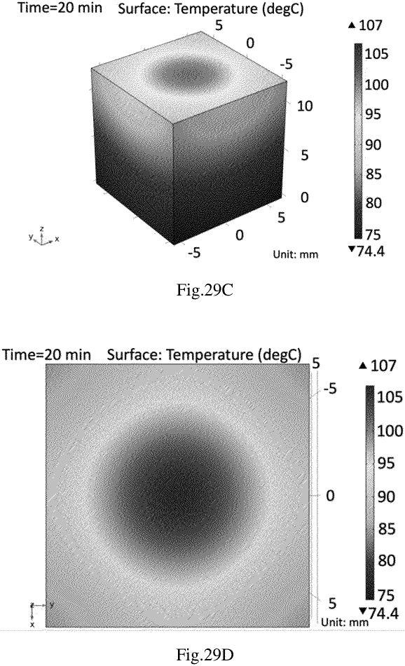

and the Gaussian laser term is

$$f \left(x , y\right) = exp \left[- 2 {\left(\frac{{x}^{2} + {y}^{2}}{{r}^{2}}\right)}^{n}\right]$$

where the laser beam was defocused to a processing radius of 6 mm. The Gaussian laser intensity profile of order 1 was implemented in FIG. 29B. The reliability of the simulation was assessed in comparison with the experimental data, according to the heat transfer theory, the temperature stabilized to a relatively steady state at 10 minutes under continuous heat energy input, which is in agreement with the experimental results at different laser power. Both temperature profiles of the experiment and simulation are raised to around 51, 78, and 105° C. at 1, 2, and 3 W laser, respectively.

### Example 23: Self-Healing Assessment Under Laser Curing

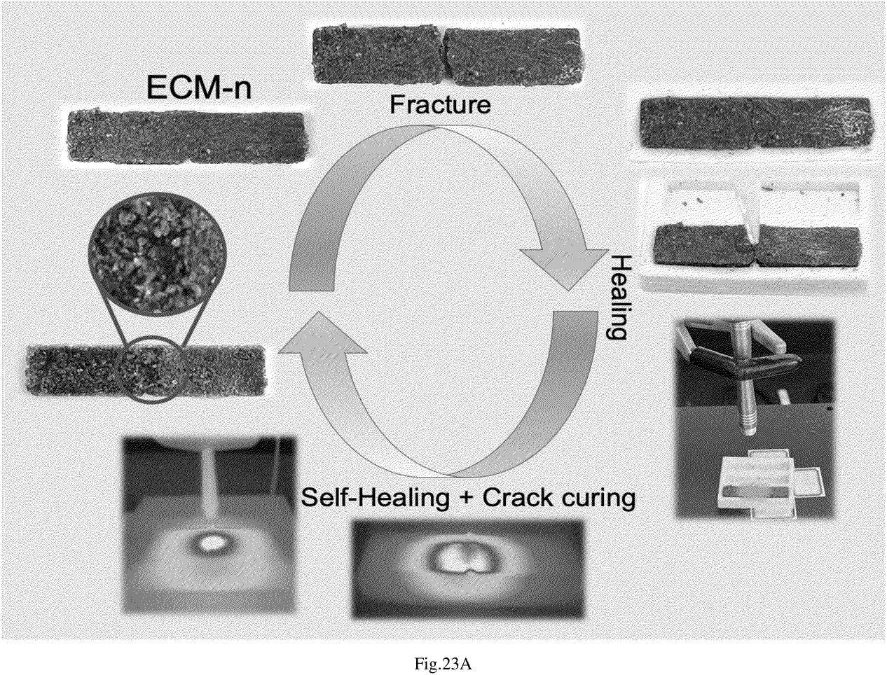

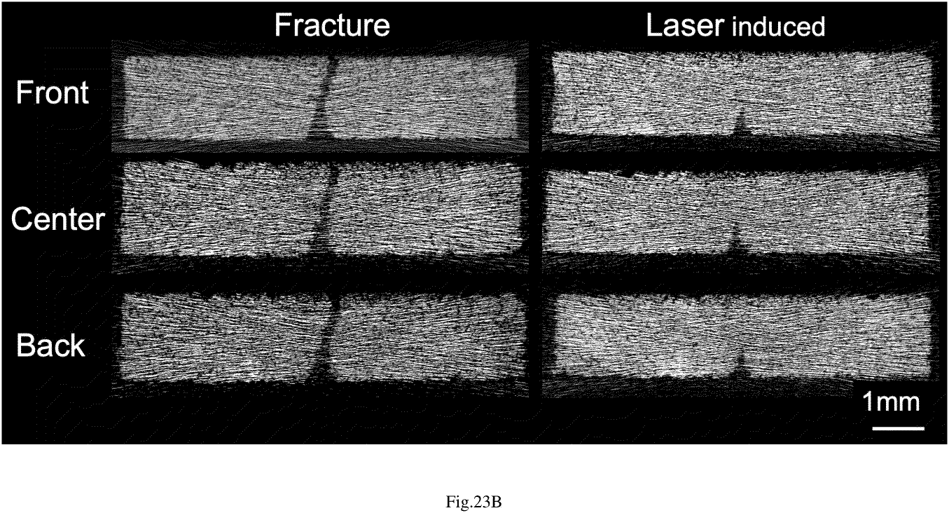

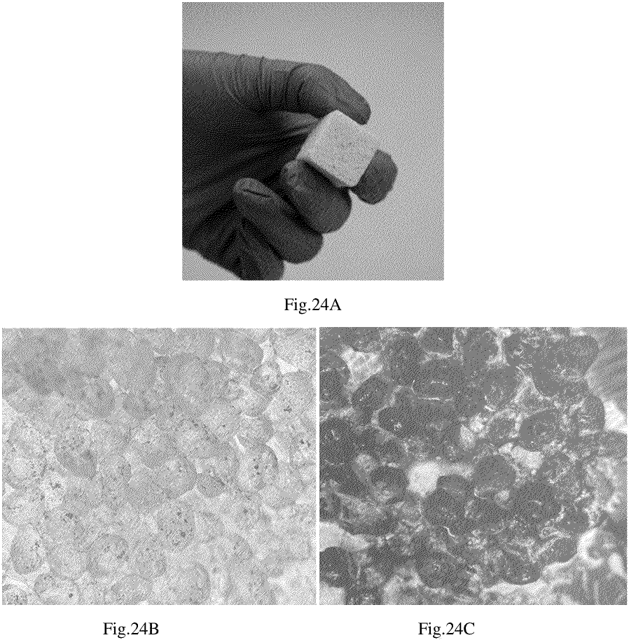

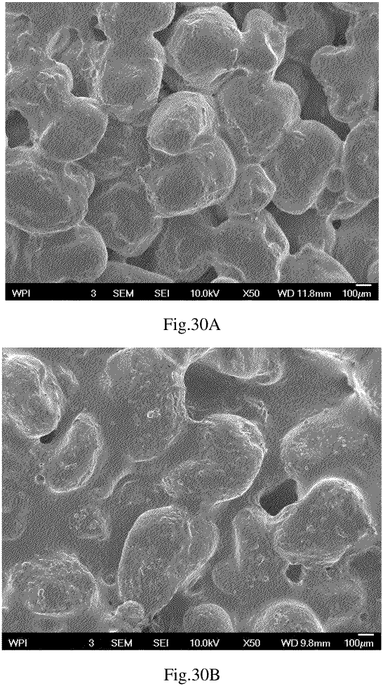

This potential feature was also demonstrated with a similar set of experiments with nanoparticles modified ECM (ECM-n), which is shown in FIG. 23A- FIG. 23B. It was observed that the ECM-n cuboid sample autonomously self-healed with laser heating without an external force or additional treatment. When fractures occur, the scaffold bridges are exposed on the fracture faces, which implies that the mineral bridges are the weak link in the microstructure of ECM. The fractured sample was assembled in a silicon mold and then the CO₂ gas was sprayed continuously on the fracture region. In the healing process, the precipitated CaCO₃ crystals were expected to gradually grow on the scaffold, and eventually bridge the fracture interface during laser heating. It was noted that the additional carbonic anhydrase was added with the calcium solution in the crack area, this is due to the decreasing enzyme activity during laser photo illumination. The fracture cuboid ECM-n sample was treated with calcium solution with a trace amount of enzyme (5 µL, 2.9 mg/mL) compared with the sample without enzyme treatment in the calcium source agent, which presented more crystals on the repaired crack after laser curing ( FIG. 30A- FIG. 30B). The macroscale characterizations of the self-healing process can also be observed from the temperature profile of the sample. The temperature profile contour changes during the healing process, as expected because the nanoparticles are carried by a fluid medium and diffused until the sample is desiccated. The 4.1 mm x 3.5 mm fracture surfaces were fully repaired after four hours of laser treatment. The resulting ECM-n has the same self-healing capability as ECM and provides a potential application for outstanding material durability. We also used microcomputed tomography (µ-CT) scanning to characterize and diagnose the internal and external microstructures of cracks within the ECMn matrix (FIG. 23B). The µ-CT scanning images clearly show the crack path disappearing in three display layers (front, center, and back), indicating that the internal crack has self-healed as predicted by laser photo illumination.

### Example 24: ECM-n Morphology and Crystallinity Characterizations

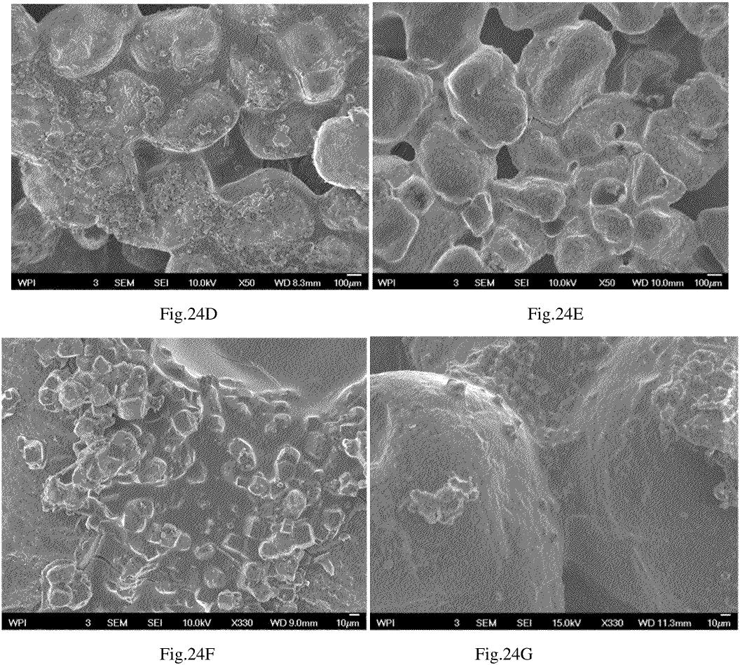

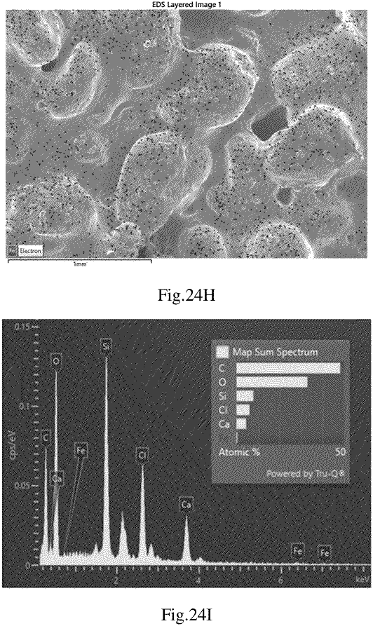

The optical and scanning electron microscope (SEM) images of the morphology of ECM and ECM-n in multiscale were presented in ( FIG. 24A- FIG. 24I), showing a variation in calcite crystals size around 10 µm. Detailed morphological characterization indicates that the laser-treated surfaces and the structure of ECM-n are similar to ECM without nanoparticles and cured in an oven. Calcite crystal distribution and the dimension of the hydrogel scaffold were not affected by the laser curing. The ordered structures were well assembled in ECM-n and ECM to efficiently shield the crack propagation. Although the sand particles and calcite crystals were assembled randomly within the polymeric scaffold, the overall view is similar to a bodycentered cubic (BCC) crystal. In the plane view, the sand particles in both samples are connected with bridges in at least four directions. Due to the characterization of BCC structural type, sand slurry materials show a high ductility during the bending test, and with a high strain at 0.0032 compared with a normal weight concrete in the range from 0.002 to 0.003. As a result, the local application of the photothermal effect by iron oxide nanoparticles exhibits a mild effect in ECM-n, showing the high extent of stability and mechanical strength in sand slurry materials structure.

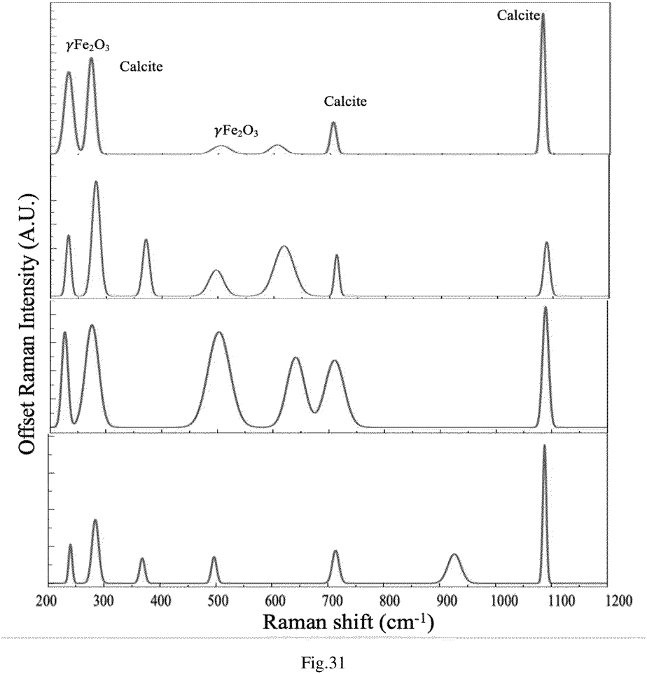

The nanoparticle distribution in ECM-n was also investigated by Energy Dispersion Spectroscopy (EDS), optical microscopy, and Raman spectroscopy, as shown in FIG. 24B, FIG. 24H, and FIG. 31, respectively. The EDS and optical images clearly show the nanoparticles distributed on each of the sand particles, correlating to a spherical temperature profile. The slight aggregation of nanoparticles occurring on the surface is due to the lack of surfactants during nanoparticle preparation. The surfactant coating consists of a variety of ester-based materials that depend on environmental factors at varying levels of chemical complexity, thus, only physical treatment was applied to the nanoparticles by the ultrasonic method to avoid a negative impact on the medium.

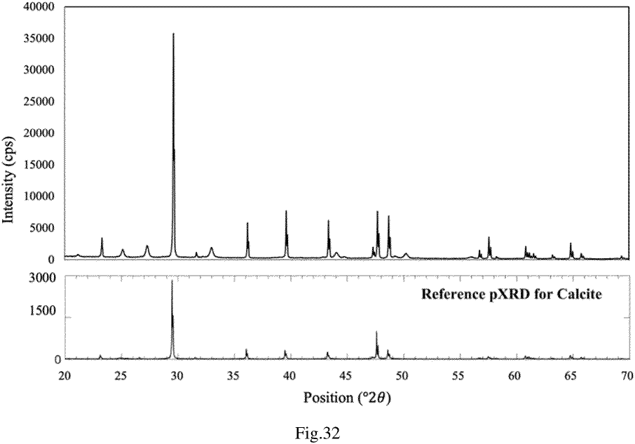

To further identify the distribution of nanoparticles as well as the precipitated crystals, four different locations on the sample surface were spotted by Raman spectroscopy. Raman spectroscopy is a nondestructive analytical technique based on changes in the scattering of low-energy light off material and can be used directly on the whole sample. FIG. 31 displays the locations on the ECM-n surface that correspond to calcite and gamma Fe2O3. The spectra were processed and plotted proportionally by fitting the Gaussian function. The Raman characteristic peak of calcium carbonate is relatively narrow, indicating a high extent of crystallization, and the intensity of the peak is higher, indicating a higher content of calcite crystals and iron oxide nanoparticles in this region of the sample surface. The above results show that the nanoparticle distribution in the ECM-n achieves the desired effect. The typical pXRD patterns in FIG. 32 show the presence of precipitated calcium carbonate on ECM-n after laser curing where a diffraction peak is observed at 2θ = 29.6 degrees, which agrees with the reference spectrum for calcite. The result verifies the crystallinity of the enzyme product as calcite. The morphology is supported by the SEM images in FIG. 24A- FIG. 24I.

### Example 25: Mechanical Properties of Repaired ECM-n

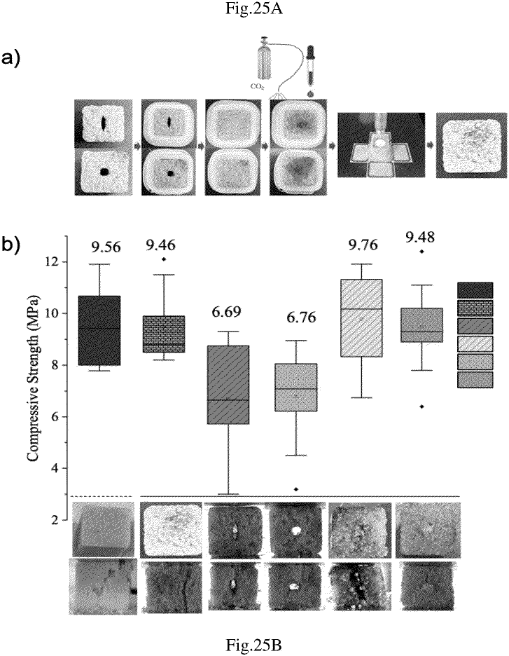

Designing high-performance construction building materials with excellent compressive strength is a long-standing engineering problem. To study the repair performance of the proposed mechanism on laser-induced curing of ECM and ECM-n, cubic-shaped specimens were fabricated for compressive testing, with two types of circular and elliptical flaws. The control and flawed samples are shown in ( FIG. 25A- FIG. 25B). It is noted that the ECM-n samples were cured by laser and the flawless ECM samples were cured in the oven. The laser-induced repairing experiment is shown in ( FIG. 25A). The normalized values of compressive strengths compared to the control are presented in ( FIG. 25B). The ECM-n samples, with a vertically oriented elliptical flaw that is 6 mm tall and 1.5 mm wide and extends through the cubic sample through the entire 12.5 mm depth representing a macroscale crack exhibit about 74% of the strength of the undamaged control specimens. The samples with a circular flaw of 2 mm diameter and extending through the entire depth of the cube sample of 12.5 mm show about 70% of the strength of the undamaged control specimens.

The compressive strength results show that cube-shaped samples with built-in flaws can regain their original compressive strength by adding the calcium enzyme mixed solution to the original sand gelatin matrix. The material was then bubbled with ultra-pure carbon dioxide for ten minutes. This is followed by the application of the laser for curing for 12 hours. The samples with a large size of the repaired flaws (~6 mm) exhibit the capability of the proposed method in the repair of the ECM specimens. It is noted that both repaired flaw shape samples slightly outperform the control samples with respect to the average compressive strength. The compatibility of the existing matrix with the additional sand-gelatin repair agent is excellent, and the repair process also allows additional curing of the original matrix, leading to an overall stiffer structure.

Comparing the results, the variation in the strength of the elliptical flaw and repaired elliptical flaw ECM-n samples is relatively high. This difference is mainly due to the geometric offset of the elliptical flaw during the sample preparation in the silicone mold. It is noted that the samples with prefabricated elliptical and circular flaw fail by crack initiation at the flaw and growth resulting from dilatation due to Poisson’s effect. The p-value of flawed ECM-n samples is less than 0.05, which leads to significant changes in the performance of the structure, while the P-value of repaired elliptical and circular flaw ECM-n are within statistical error (>0.05). Therefore, ECM-n with flaws maintains mechanical stability after repair by the laser.

### Example 26: Embodied Energy and CO₂ of ECM/ECM-n

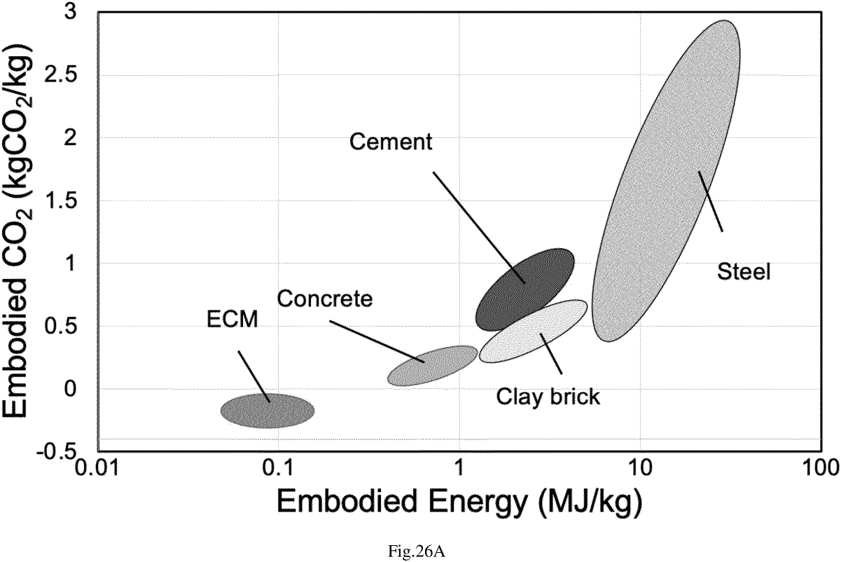

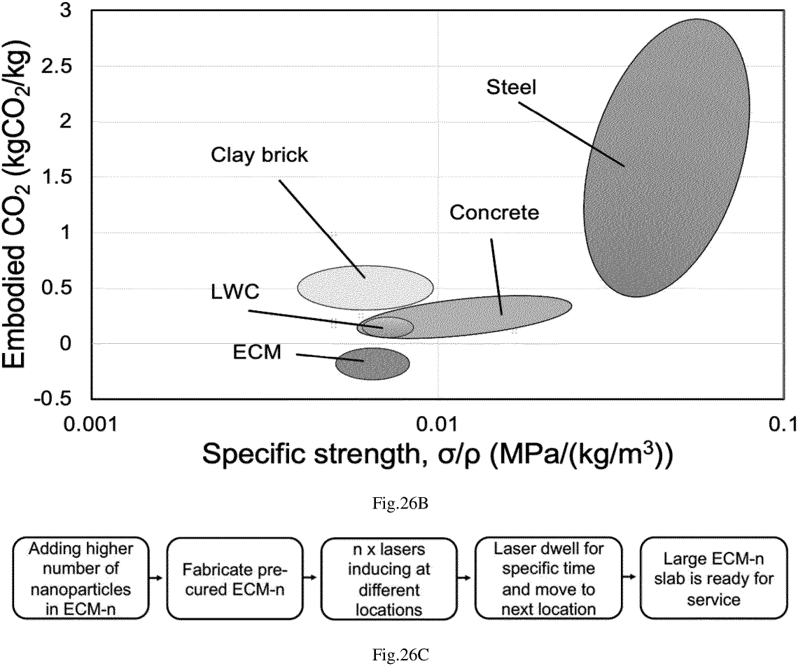

To visualize the impact of ECM/ECM-n on sustainable environmental protection and various types of construction materials, the embodied energy vs. embodied CO₂ and specific strength vs. embodied CO₂ associated with different construction materials were compared ( FIG. 26A and FIG. 26B). The Ashby diagram of embodied energy versus embodied strength shows that ECM/ECM-n consumes CO₂ as seen by negative values compared to other construction materials, this is because the formation of the ECM/ECM-n requires the consumption of carbon dioxide. Furthermore, the ECM/ECM-n presents relatively low energy consumption.

The boundaries that were considered in this study are cradle-to-gate. Thus, the transportation consuming energy and manufacturing processes of ECM/ECM-n were recognized similarly to concrete in this report. The negative CO₂ emissions and low energy embodiment of ECM/ECM-n are because most of the components can be obtained directly in nature or by simple secondary processing. The enzyme, carbonic anhydrase, which is added in trace amounts, is isolated from bovine erythrocytes or other natural sources, which does not generate carbon dioxide, and requires little energy. The calcium can be obtained from natural brines as a byproduct of synthetic soda ash production. Another low-carbon method is to produce calcium from hydrochloric acid and limestone. The process will generate hydrogen that can be directly burned or generated by fuel cells to obtain water, which can be achieved by true zero carbon emissions without polluting the environment. The gelatin is extracted by hydrolysis of biological material in a process that is essentially zero-emission. In the methods described herein, only 0.1% (by sand weight) nanoparticles were applied in the medium and the nanoparticles are known to be a clean product that can capture and utilize CO₂ from the air. The specific mechanical properties of ECM/ECM-n were also compared with other construction materials in FIG. 26B. Cracking is assumed to be the initiation of concrete failure. The specific strength of ECM/ECM-n was comparable to the LWC (lightweight concrete) and the minimum of the commercial concrete. There is no negative impact of nanoparticles between ECM and ECM-n, which result in the same mechanical properties.

These materials can entirely replace lightweight concrete and masonry blocks in all their applications. Especially, the ECM-n can rapidly be constructed for the temporary base, secondary structure, and pipe in extreme weather. Here, a guiding flow chart is provided as a reference ( FIG. 26C). From the above results, the effective area of ECM-n is proportional to the number of nanoparticles and the power of the laser. Therefore, in on-site construction, a higher number of nanoparticles and higher power of laser are suggested to apply on the ECM-n to guarantee the desired effects. For example: to fabricate a 10 ft X 10 ft ECM-n slab, precured ECM-n can be prepared on the foundation, and then ten industrial laser machines can be induced at different spots (assuming the effective area is 0.5 ft X 0.5 ft). Designing the laser dwell at each spot for a specific time to achieve full curing (3 W laser induces 4 hours for a 12.5 mm depth) before moving to the next spot. The total time should be around 160 hours without considering the ambient humidity and natural drying rate, but this will decrease exponentially with an increase in the number of nanoparticles added. However, achieving the balance between time effectiveness and power cost is the key to this process.

### Example 27: Laser-Induced Curing of ECM-n

The laser diode corresponds to a heating power of 3 W. The laser beam was transmitted through a fiber optic cable to the tip of a cylindrical probe before propagating into the sample. The distance between the tip of the probe and the sample surface was set at 2 cm to achieve a laser spot size of 1 cm on the samples. The temperatures of the heated surfaces of samples were recorded with an infrared camera (FLIR One Pro). Subsequently, the 12.5 mm cubic sample was heated and dehydrated in the silicon mold for twelve hours. The cuboid samples (38 mm in length, 8.3 mm in depth, 4.1 mm in width, and 1.1 mm in notch length) were fabricated in the same method. Due to the limited size of the laser beam, the cuboid sample was spotted at three different locations (left, center, and right) for 5 hours at each point to achieve a fully dehydrated specimen.

### Example 28: Laser-Induced Self-Healing of Cuboid Samples

The single edge notch cuboid sample was fractured into two parts. The parts were assembled and placed into the original mold. 1 mL (5 uL enzyme, concentration: 2.9 mg/mL) of calcium enzyme solution was added to the crack region. Ultra-pure CO₂ was introduced on the surface for fifteen minutes to precipitate the calcite crystals and form a prototype of the bridges. The sample was then settled for another fifteen minutes, allowing the mineralization solution to penetrate naturally into the interior of the structure. The 3 W laser was set up 2 cm above the sample and conducted on the crack for 6 hours, then the sample was able to be taken out of the mold.

### Example 29: Repairing Procedure for ECM-n

ECM-n were fabricated and cured in a 3D print silicone mold with an elliptical and circular shape notch. After heating with the 3 W laser for 12 hours, the sample was taken out of the mold and transferred to a cubic silicon mold. The notch was filled with well-mixed sand gelatin components, and the sample was then vibrated for thirty seconds. 200 µL calcium carbonic anhydrate mixed solution with nanoparticles were added on the notched surface and then aerated by CO₂ for 15 minutes. This process should be slow enough to ensure that the solution penetrates to the bottom and does not affect the surrounding structures. 3 W laser was induced on the sample from the same distance on the repaired surface for 12 hours and was finally taken out of the mold.

### Example 30: Mineralogical Assessment of Precipitates

The crystal and nanoparticles in ECM-n samples were segregated from the gelatin and sand matrix for assessment of the mineral phase in ECM-n after laser inducing for twelve hours. Dried crystals and nanoparticle mixtures were ground with the mortar and smear-mounted on a sample holder for fingerprint XRD. A Siemens D500 X-ray diffractometer analyzed the samples from to 70° 2θ using Cu K-α X-ray radiation with a step size of 0.02° and a dwell time of 2 s per step. Mineral phases were collected using a data collector. The laser-cured ECM-n was evaluated using JEOL JSM-7000F Analytical SEM. Samples were first sputter coated with gold powder. Electron-dispersive spectroscopy (EDS) was employed to assess the nanoparticle distribution in the ECM-n matrix.

### Example 31: Raman Spectroscopy

A hybrid system (XploRA, HORIBA, France) was used to obtain optical images and Raman spectra ranging from 100-1200 cm⁻¹. The experiment was employed with a diode laser (λ = 785 nm), and the filter was set up at 10% and x100 objectives. The acquisition time and accumulation were defined as 5 and 20, respectively.

### Example 32: Heat Released Analysis During the Initial Curing

Isothermal Titration Calorimetry (ITC) can measure the thermal power (heat production rate) produced by the hydration reactions of cementitious materials. Additionally, ITC tracks the rate of the overall reaction of the material and visualizes the behavior of the hydration in a way that a simple set time or a compressive strength test does not. The timing and shape of the heat flow curve obtained by calorimetry indicate the relative performance of concrete and potential adverse interactions between materials used in the mixes.

### Example 33: Laser Heating ECM-n In Low and Room Temperatures

All the physical and thermal properties of the ECM-n sample were extracted from experimental data to be used in the FEM. The geometry of the ECM-n was modeled with standard 8 node linear heat transfer elements in three dimensions, which is shown in FIG. 29A. To develop multi-functional properties of ECM, the laser thermal mechanism and heating process in ECM-n was investigated, and simulated the temperature gradient, assuming the material properties are not temperature-dependent since there is no phase change during the heating process. FIG. 29C and FIG. 29D present the highest temperature profile located under the laser beam as a function of time, which agree with the experimental observations in FIG. 21A- FIG. 21C.

### Example 34: ECM-n Morphology and Crystallinity Characterizations

Raman spectroscopy can provide qualitative analysis of sample phases and morphology, crystallinity, and molecular interactions. The peak profiles are generally defined by three parameters: peak intensity, width, and position. The peak intensity is affected by object concentration and orientation. The peak width is related to crystallinity and homogeneity, and the peak position is associated with the components. The carbonate phase (calcite) and gamma Fe2O3 comprise major portions of the material and are relatively easily identified through a phase (~1086 cm-1) and Fe2O3 band (-225 cm-1) since both are strong Raman scatterers.

What is claimed is:

1. A self-healing construction material compound, the compound comprising:
an aggregate matter;
a catalyst;
a scaffolding material; and
a calcium source.

2. The compound according to claim 1, wherein the compound is a carbon negative compound.

3. The compound according to claim 1, wherein the aggregate matter further comprises sand aggregates.

4. The compound according to claim 1, wherein the scaffolding material further comprises a crosslinking agent selected from glutaraldehyde, and tannin.

5. The compound according to claim 1, wherein the scaffolding material comprises a polymer.

6. The compound according to claim 5, wherein the scaffolding material is gelatin.

7. The compound according to claim 1, wherein the catalyst is carbonic anhydrase.

8. The compound according to claim 1 further comprising a source of carbon dioxide.

9. The compound according to claim 1, wherein the compound sequesters atmospheric carbon dioxide.

10. The compound according to claim 1, wherein the compound has a mechanical strength from at least 10 MPa to at least 16 MPa.

11. The compound according to claim 1 further comprises at least one of: a light source, a heat source, a laser source, and a magnetic field application source.

12. The compound according to claim 1, wherein the compound is configured to form mineral bridges between the aggregate matter to obtain a dense mass.

13. The compound according to claim 1, wherein the catalyst is configured to operate at a pH of 6.5 to 8.5.

14. The compound according to claim 1, wherein the catalyst is configured to operate at a temperature up to 50° C.

15. The compound according to claim 1 further comprises a quantity of nanoparticles.

16. A method for making a carbon sequestering construction material, the method comprising:
preparing a catalytic solution having a catalyst and a calcium solution;
mixing an aggregate matter with a scaffolding material to obtain a slurry; and
adding the enzymatic solution and the calcium solution to the slurry, wherein the catalyst utilizes carbon dioxide from atmosphere and calcium from the calcium solution to form calcium carbonate crystals thereby sequestering carbon and obtaining a carbon sequestering construction material.

17. The method according to claim 16, wherein the calcium carbonate crystals are deposited on the aggregate matter to create mineral bridges.

18. The method according to claim 16 further comprising dehydrating the construction material for facilitating crosslinking between scaffolding material.

19. The method according to claim 16, wherein the calcium solution is configured to facilitate continuous precipitation of the calcium carbonate crystals.

20. A carbon negative self-healing construction material compound, the compound comprising:
a quantity of sand aggregates;
a quantity of carbonic anhydrase catalyst;
a gelatin scaffolding material;
a calcium solution; and
a quantity of iron oxide nanoparticles.

21. The compound according to claim 20 further comprises a laser source or a light source for curing the compound.
